(19) United States
(12) Patent Application Publication
(10) Pub. No.: US 2023/0169436 A1
(43) Pub. Date: Jun. 1, 2023

(54) METHOD FOR ONLINE EVALUATION AND ONLINE SERVER FOR EVALUATION

(71) Applicant: VISITS Technologies, Inc., Tokyo (JP)

(72) Inventors: Masaru MATSUMOTO, Tokyo (JP); Minoru KURIYAMA, Tokyo (JP)

(21) Appl. No.: 17/916,006

(22) PCT Filed: Mar. 15, 2021
(86) PCT No.: PCT/JP2021/010437

§ 371 Date: Sep. 29, 2022

(30) Foreign Application Priority Data
Apr. 14, 2020 (JP) 2020-072523

(51) Int. Cl. G06Q 10/0639

(52) U.S. Cl. CPC G06Q 10/06393

(57) ABSTRACT

Evaluators evaluates an evaluation target via a network, and the obtained evaluation data is stored in a server using identifiers. Judgement by judges regarding a magnitude of a persuasive power of each evaluator is performed via the network in a manner in which the evaluator cannot be identified, and the obtained judgement data is stored in the server using identifiers. The magnitude of the persuasive power of the evaluators is ranked based on the judgement data, and stored in the server using identifiers. A weighted evaluation distribution for the evaluation target is calculated and stored in the server based on the evaluation by each evaluator stored in the server and the rating regarding the magnitude of the persuasive power of each evaluator, provided that as the rating regarding the magnitude of the persuasive power of the evaluator is higher, a greater weighting is given to the evaluation by the evaluator.

### FIELD OF THE INVENTION

The present invention relates to a method for performing an online evaluation. The present invention also relates to a server for performing an online evaluation.

### BACKGROUND OF THE INVENTION

There are many situations in the world where things are evaluated and some decisions are made according to the evaluation results. In a familiar example, there are cases where company value is evaluated. If it is judged that a company has high growth potential, it will be a promising investment destination. In addition, there are innumerable other evaluation targets, and various evaluation targets in various fields such as politics, economy, society, industry, science, and environment exist. Further, within a company, there are various evaluation targets in various departments such as personnel, labor, education, accounting, legal affairs, corporate planning, technological development, security, information management, marketing and sales.

When evaluating things, it is more effective to comprehensively evaluate them by a plurality of persons rather than by one person in order to enhance the objectivity of the evaluation. In addition, with the progress of Internet technology, it is possible to collect evaluations from a large number of evaluators online.

For example, Japanese Patent Application Publication No. 2014-500532 proposes a method wherein examinees evaluate each other's answers for a question without a model answer. It is disclosed in the literature that a system comprises a memory device resident in a computer and a processor provided in communication with the memory device, wherein the processor is configured to request a candidate to create a question based on a theme; to receive the question from the candidate; to request an evaluation of the question and the theme from at least one evaluator; and to receive a question score from each evaluator, wherein the question score is an objective measure of the evaluation of the question and the evaluator; to receive a grade for each evaluator; and to calculate a grade for the candidate based on the question score from each evaluator and the grade for each evaluator.

In addition, in WO 2017/145765, there is disclosed an online test method that enables simple and objective measurement of each examinee's idea creativity by determining the connoisseurship of each examinee and reflecting the result in each examinee's evaluation. Specifically, there is disclosed an online test method to evaluate an innovation ability such as the ability to create many highly evaluated ideas, the ability to create a wide range of highly evaluated ideas, or the ability to create rare and highly evaluated ideas, in which an online test is conducted in which a number of examinees are asked to select a situation setting related to 5W1H from the options and to describe their ideas as much as possible within the time limit, and the answers from the examinees are weighted according to a predetermined standard and the total score is calculated.

### CITATION LIST

### Patent Literature

[Patent Literature 1] Japanese Patent Publication No. 2014-500532

[Patent Literature 2] WO 2017/145765

### SUMMARY OF THE INVENTION

The scale for evaluating things varies from evaluator to evaluator. In addition, different evaluations can be made depending on the evaluator's experience, knowledge, environment, personality, and the like. Therefore, the evaluation result for the same thing may differ depending on the evaluator. When the opinions of the evaluators are divided, it is usual for the evaluators to discuss with each other and summarize the evaluation results to draw a conclusion. However, depending on the human relationships, ranks, power relationships, or the like among the evaluators, a bias may occur and a situation may occur in which the opinions of a specific evaluator must be agreed. In addition, there may be a situation in which the opinions of aggressive evaluators are likely to be reflected in the evaluation results. When trying to evaluate things properly from an objective standpoint, it is desirable to be able to eliminate the influence of the power balance among evaluators as much as possible.

The present invention has been created in view of the above circumstances, and in one embodiment, an object of the present invention is to provide a method for online evaluation of things with high objectivity that is not affected by the power balance among evaluators. Further, in another embodiment, another object of the present invention is to provide an online server for efficiently evaluating things.

As a result of diligent studies to solve the above problems, the present inventors have found that the following methods and servers for online evaluation in which evaluations for evaluation targets can be performed anonymously while sharing them among a plurality of evaluators are effective.

[1]

A method for online evaluation, comprising:

a step in which a server receives an instruction to start an evaluation session from an administrator terminal via a network;

a step in which, in response to the instruction to start the evaluation session, the server extracts information on an evaluation target from an evaluation target information storage part, and extracts a first format data for evaluation input including a selective evaluation input section based on at least one evaluation axis and at least one descriptive comment input section from a first format data storage part, and transmits the information on the evaluation target and the first format data to each of a plurality of evaluator terminals of the evaluation session via the network;

a step in which the server receives an evaluation data including evaluation of the evaluation target input by each evaluator in the selective evaluation input section and the descriptive comment input section from each of the evaluator terminals via the network;

a step in which the server assigns an identifier to each of the received evaluation data including the evaluation of the evaluation target, and stores the evaluation data in an evaluation data storage part in association with an identifier of each evaluator who has transmitted the evaluation data;

a step in which the server determines judges from among the evaluators who should judge a persuasive power of the evaluator in each evaluation data stored in the evaluation data storage part;

a step in which, according to a result of the step of determining the judges who should judge the persuasive power of the evaluator, the server extracts the evaluation data including the evaluation to be judged by each judge from the evaluation data storage part, and extracts a second format data including a selective judgement input section for inputting judgement regarding a magnitude of the persuasive power for each evaluation axis from a second format data storage part, and transmits the evaluation data and the second format data to a corresponding judge terminal via the network in a manner in which the judge cannot identify the evaluator who has input the evaluation;

a step in which the server receives a judgement data including the judgement of the persuasive power of the evaluator input by each judge in the selective judgement input section from each judgement terminal via the network;

a step in which the server assigns an identifier to each of the received judgement data and stores the judgement data in a judgement data storage part in association with the identifier of the judge who has transmitted the judgement data and with the identifier of the evaluation data which has received the judgement;

a step in which the server ranks the persuasive power of each evaluator who has received the judgement for each evaluation axis based on the judgement regarding the magnitude of the persuasive power of the evaluator input by each judge in the selective judgement input section in the judgement data stored in the judgement data storage part, and stores as a rating data regarding the magnitude of the persuasive power of the evaluator in an evaluator rating data storage part in association with the identifier of each evaluator;

a step in which the server calculates a weighted evaluation distribution for the evaluation target for each evaluation axis, based on the evaluation input by each evaluator in the selective evaluation input section in the evaluation data stored in the evaluation data storage part and the rating regarding the magnitude of the persuasive power of each evaluator stored in the evaluator rating data storage part, provided that as the rating regarding the magnitude of the persuasive power of the evaluator is higher, a greater weighting is given to the evaluation by the evaluator, and the sever stores the weighted evaluation distribution in an evaluation analysis data storage part for each evaluation axis;

and a step in which the server extracts an evaluation analysis data including the weighted evaluation distribution itself and/or statistics calculated based on the evaluation distribution stored in the evaluation analysis data storage part, and transmits the evaluation analysis data to the administrator terminal via the network.

[2]

The method for online evaluation according to [1], wherein the step, in which the server ranks the persuasive power of each evaluator who has received the judgement for each evaluation axis based on the judgement regarding the magnitude of the persuasive power of the evaluator input by each judge in the selective judgement input section in the judgement data stored in the judgement data storage part, and stores as the rating data regarding the magnitude of the persuasive power of the evaluator in the evaluator rating data storage part in association with the identifier of each evaluator, comprises a step in which the server ranks a first magnitude of the persuasive power of each evaluator who has received the judgement for each evaluation axis based on the judgement regarding the magnitude of the persuasive power of the evaluator input by each judge in the selective judgement input section, and stores as a first rating data regarding the magnitude of the persuasive power of the evaluator in the evaluator rating data storage part in association with the identifier of each evaluator; followed by a step performed at least once in which the server ranks a second magnitude of the persuasive power of each evaluator who has received the judgement for each evaluation axis, based on the judgement regarding the persuasive power of the evaluator input by each judge in the selective judgement input section and the first rating data stored in the evaluator rating data storage part, provided that as the rating regarding the first magnitude of the persuasive power of the evaluator is higher, a greater weighting is given to the judgement by the evaluator, and the server stores as a second rating data regarding the magnitude of the persuasive power of the evaluator in the evaluator rating data storage part in association with the identifier of each evaluator.

[3]

The method for online evaluation according to [1] or [2], comprising:

a step in which the server calculates a pre-weighted evaluation distribution for the evaluation target for each evaluation axis based on the evaluation input by each evaluator in the selective evaluation input section in the evaluation data stored in the evaluation data storage part, and stores the pre-weighted evaluation distribution in the evaluation analysis data storage part for each evaluation axis; and

a step in which the server extracts an evaluation analysis data including the pre-weighted evaluation distribution itself and/or statistics calculated based on the evaluation distribution stored in the evaluation analysis data storage part, and transmits the evaluation analysis data to the administrator terminal via the network.

[4]

The method for online evaluation according to any one of [1] to [3], comprising: a step in which the server calculates a first aggregated score of the evaluation of the evaluation target for each evaluation axis based on the evaluation input by each evaluator in the selective evaluation input section in the evaluation data stored in the evaluation data storage part, and stores the first aggregated score in the evaluation analysis data storage part for each evaluation axis;

a step in which the server calculates a second aggregated score of the evaluation of the evaluation target for each evaluation axis based on the evaluation input by each evaluator in the selective evaluation input section in the evaluation data stored in the evaluation data storage part and the rating regarding the magnitude of the persuasive power of each evaluator stored in the evaluator rating data storage part, provided that as the rating regarding the magnitude of the persuasive power of the evaluator is higher, a greater weighting is given to the evaluation by the evaluator, and the sever stores the second aggregated score in the evaluation analysis data storage part for each evaluation axis; and

a step in which the server extracts an evaluation analysis data including the first aggregated score and the second aggregated score stored in the evaluation analysis data storage part and transmits the evaluation analysis data to the administrator terminal via the network.

[5]

The method for online evaluation according to [4], comprising:

a step in which the server aggregates a score fluctuation risk for each evaluation axis based on a magnitude of a difference between the evaluation input by each evaluator in the selective evaluation input section in the evaluation data stored in the evaluation data storage part and the second aggregated score in the evaluation analysis data stored in the evaluation analysis data storage part, and based on the rating regarding the magnitude the persuasive power of each evaluator stored in the evaluator rating data storage part, and the server stores the score fluctuation risk in the evaluation analysis data storage part, wherein as the rating regarding the magnitude of the persuasive power of the evaluator is higher, a greater weighting is given to the evaluation by the evaluator when aggregating the score fluctuation risk; and

a step in which the server extracts an evaluation analysis data including the score fluctuation risk stored in the evaluation analysis data storage part and transmits the evaluation analysis data to the administrator terminal via the network.

[6]

The method for online evaluation according to [4] or [5], comprising:

a step in which the server compares the evaluation input by each evaluator in the selective evaluation input section in the evaluation data stored in the evaluation data storage part and the second aggregated score in the evaluation analysis data stored in the evaluation analysis data storage part, and provided that a higher rating is given as proximity between them is higher, the server ranks a magnitude of a connoisseurship of each evaluator for each evaluation axis, and stores a rating data regarding the magnitude of the connoisseurship of the evaluator in the evaluator rating data storage part in association with the identifier of each evaluator; and a step in which the server extracts the rating data regarding the magnitude of the connoisseurship of the evaluator stored in the evaluator rating data storage part for each evaluator and transmits the rating data to the administrator terminal via the network.

[7]

The method for online evaluation according to any one of [4] to [6], comprising: a step in which the server calculates a first comprehensive evaluation score for the evaluation target based on the first aggregated score for each evaluation axis in the evaluation analysis data stored in the evaluation analysis data storage part, and stores the first comprehensive evaluation score in the evaluation analysis data storage part;

a step in which the server calculates a second comprehensive evaluation score for the evaluation target based on the second aggregated score for each evaluation axis in the evaluation analysis data stored in the evaluation analysis data storage part, and stores the second comprehensive evaluation score in the evaluation analysis data storage part; and

a step in which the server extracts an evaluation analysis data including the first comprehensive evaluation score and the second comprehensive evaluation score stored in the evaluation analysis data storage part and transmits the evaluation analysis data to the administrator terminal via the network.

[8]

The method for online evaluation according to [7], comprising:

a step in which the server receives an instruction from the administrator terminal via the network to change a degree of influence of the aggregated score for each evaluation axis on the comprehensive evaluation score;

a step in which the server changes the degree of influence that the first aggregated score for each evaluation axis has on the first comprehensive evaluation score in response to the instruction to change the degree of influence, and calculates a corrected first comprehensive evaluation score for the evaluation target based on the first aggregated score for each evaluation axis in the evaluation analysis data stored in the evaluation analysis data storage part, and stores the corrected first comprehensive evaluation score in the evaluation analysis data storage part;

a step in which the server changes the degree of influence that the second aggregated score for each evaluation axis has on the second comprehensive evaluation score in response to the instruction to change the degree of influence, and calculates a corrected second comprehensive evaluation score for the evaluation target based on the second aggregated score for each evaluation axis in the evaluation analysis data stored in the evaluation analysis data storage part, and stores the corrected second comprehensive evaluation score in the evaluation analysis data storage part; and

a step in which the server transmits the corrected first comprehensive evaluation score and the corrected second comprehensive evaluation score stored in the evaluation analysis data storage part to the administrator terminal via the network.

[9]

The method for online evaluation according to any one of [1] to [8], wherein the at least one evaluation axis comprises at least one selected from the group consisting of growth potential of the evaluation target, stability of the evaluation target, and social contribution of the evaluation target.

[10]

The method for online evaluation according to any one of [1] to [9], wherein the at least one evaluation axis comprises two or more evaluation axes.

[11]

The method for online evaluation according to any one of [1] to [10], comprising a step in which the server extracts for each evaluator the rating data regarding the magnitude of the persuasive power of the evaluator stored in the evaluator rating data storage part, and transmits the rating data to the administrator terminal via the network.

[12]

The method for online evaluation according to any one of [1] to [11], wherein the rating data regarding the magnitude of the persuasive power of the evaluator includes a relative score among the evaluators on the magnitude of the persuasive power.

[13]

The method for online evaluation according to any one of claims 1 to 12, comprising: a step in which the server ranks a magnitude of an explanatory power of each evaluator who has received the judgement for each evaluation axis, based on the judgement regarding the magnitude of the persuasive power of the evaluator input by each judge in the selective judgement input section in the judgement data stored in the judgement data storage part and based on a magnitude of a difference between the evaluation of the evaluation target input by the judge and the evaluation of the evaluation target input by the evaluator who has received the judgement from the judge in the evaluation data stored in the evaluation data storage part, provided that a higher rating is given as the magnitude of the persuasive power and the difference in the evaluation are greater, and the server stores as a rating data regarding the magnitude of the explanatory power of the evaluator in the evaluator rating data storage part in association with the identifier of each evaluator; and a step in which the server extracts the rating data regarding the magnitude of the explanatory power of the evaluator stored in the evaluator rating data storage part for each evaluator and transmits the rating data to the administrator terminal via the network.

[14]

The method for online evaluation according to any one of [1] to [13], comprising a step in which the server extracts for each evaluator the evaluation data including the evaluation input by each evaluator in the selective evaluation input section and the descriptive comment input section, and transmits the evaluation data to the administrator terminal via the network.

[15]

The method for online evaluation according to any one of [1] to [14], comprising:

a step in which the server compares the judgement regarding the magnitude of the persuasive power of the evaluator input by each judge in the selective judgement input section in the judgement data stored in the judgement data storage part and the rating regarding the magnitude of the persuasive power of the evaluator stored in the evaluator rating data storage part, and provided that a higher rating is given as proximity between them is higher, the server ranks a magnitude of a connoisseurship of each judge for each evaluation axis, and stores as a rating data regarding the magnitude of the connoisseurship of the judge in a judge rating data storage part in association with the identifier of each judge; and

a step in which the server extracts the rating data regarding the magnitude of the connoisseurship of the judge stored in the judge rating data storage part for each judge and transmits the rating data to the administrator terminal via the network.

[16]

The method for online evaluation according to any one of [1] to [15], wherein the second format data further includes a selective evaluation re-input section for inputting a re-evaluation of the evaluation target for each evaluation axis, and the judgement data further includes a re-evaluation data including a re-evaluation of the evaluation target input by each judge in the selective evaluation re-input section.

[17]

The method for online evaluation according to [16], wherein the rating by the server on the magnitude of the persuasive power of each evaluator who has received the judgement for each evaluation axis is performed based on the judgement regarding the magnitude of persuasive power of the evaluator input by each judge in the selective judgement input section and based on the re-evaluation of the evaluation target input by each judge in the selective evaluation re-input section, in the judgement data stored in the judgement data storage part.

[18]

An online server for evaluation, comprising a transceiver, a control unit, and a storage unit,

the storage unit comprising:
an evaluation target information storage part for storing information on an evaluation target;
a first format data storage part for storing a first format data for evaluation input including a selective evaluation input section based on at least one evaluation axis and at least one descriptive comment input section;
an evaluation data storage part for storing an evaluation data including an evaluation of the evaluation target input by each evaluator in the selective evaluation input section and the descriptive comment input section received by the transceiver, together with an identifier of the evaluation data in association with an identifier of each evaluator who has transmitted the evaluation data;
a second format data storage part for storing a second format data including a selective judgement input section for inputting judgement regarding a magnitude of a persuasive power for each evaluation axis;
a judgement data storage part for storing a judgement data including a judgement of a persuasive power of the evaluator input by each judge in the selective judgement input section received by the transceiver, together with an identifier of the judgement data in association with an identifier of the judge who has transmitted the judgement data and the identifier of the evaluation data which has received the judgement;
an evaluation analysis data storage part for storing a weighted evaluation distribution for the evaluation target for each evaluation axis; and
an evaluator rating data storage part for storing a rating data regarding the magnitude of the persuasive power of the evaluator in association with the identifier of each evaluator;

the control unit comprising an evaluation input data extraction part, a judgement input data extraction part, a data registration part, a judge determination part, an evaluation analysis part, and an evaluation analysis data extraction part, wherein:
the evaluation input data extraction part is configured to extract the information on the evaluation target from the evaluation target information storage part when the transceiver receives an instruction to start an evaluation session from an administrator terminal via a network, and to extract the first format data for evaluation input including the selective evaluation input section based on the at least one evaluation axis and the at least one descriptive comment input section from the first format data storage part, and to transmit the information on the evaluation target and the first format data to each of a plurality of evaluator terminals of the evaluation session from the transceiver via the network;
the data registration part is configured to assign the identifier to each of the evaluation data received by the transceiver, and store the evaluation data in the evaluation data storage part in association with the identifier of each evaluator who has transmitted the evaluation data, and is configured to assign the identifier to each of the judgement data received by the transceiver, and store the judgement data in the judgement data storage part in association with the identifier of the judge who has transmitted the judgement data and the identifier of the evaluation data which has received the judgement;
the judge determination part is configured to determine judges from among the evaluators who should judge the persuasive power of the evaluator in each evaluation data stored in the evaluation data storage part;
the judgement input data extraction part is configured to extract the evaluation data including the evaluation to be judged by each judge from the evaluation data storage part according to a determination by the judge determination part on the judges who should judge the persuasive power of the evaluator, and is configured to extract the second format data including the selective judgement input section for inputting judgement regarding the magnitude of the persuasive power for each evaluation axis from the second format data storage part, and to transmit the evaluation data and the second format data from the transceiver to a corresponding judge terminal via the network in a manner in which the judge cannot identify the evaluator who has input the evaluation;
the evaluation analysis part is configured to rank the magnitude of the persuasive power of each evaluator who has received the judgement for each evaluation axis based on the judgement regarding the magnitude of the persuasive power of the evaluator input by each judge in the selective judgement input section in the judgement data stored in the judgement data storage part, and to store as a rating data regarding the magnitude of the persuasive power of the evaluator in the evaluator rating data storage part in association with the identifier of each evaluator,
and the evaluation analysis part is configured to calculate the weighted evaluation distribution for the evaluation target for each evaluation axis based on the evaluation input by each evaluator in the selective evaluation input section in the evaluation data stored in the evaluation data storage part and the rating regarding the magnitude of the persuasive power of each evaluator stored in the evaluator rating data storage part, provided as the rating regarding the magnitude of the persuasive power is higher, a greater weighting is given to the evaluation by the evaluator, and is configured to store the weighted evaluation distribution in the evaluation analysis data storage part for each evaluation axis; and
the evaluation analysis data extraction part is configured to extract an evaluation analysis data including the weighted evaluation distribution itself and/or statistics calculated based on the evaluation distribution stored in the evaluation analysis data storage part, and to transmit the evaluation analysis data from the transceiver to the administrator terminal via the network.

[19]

The online server for evaluation according to [18], wherein when the evaluation analysis part ranks the magnitude of the persuasive power of each evaluator who has received the judgement for each evaluation axis based on the judgement regarding the magnitude of the persuasive power of the evaluator input by each judge in the selective judgement input section in the judgement data stored in the judgement data storage part, and stores as the rating data regarding the magnitude of the persuasive power of the evaluator in the evaluator rating data storage part in association with the identifier of each evaluator, the evaluation analysis part is configured to perform a step in which the evaluation analysis part ranks a first magnitude of the persuasive power of each evaluator who has received the judgement for each evaluation axis based on the judgement regarding the magnitude of the persuasive power of the evaluator input by each judge in the selective judgement input section, and stores as a first rating data regarding the magnitude of the persuasive power of the evaluator in the evaluator rating data storage part in association with the identifier of each evaluator; followed by a step the evaluation analysis part is configured to perform at least once in which the evaluation analysis part ranks a second magnitude of the persuasive power of each evaluator who has received the judgement for each evaluation axis, based on the judgement regarding the persuasive power of the evaluator input by each judge in the selective judgement input section and the first rating data stored in the evaluator rating data storage part, provided that as the rating regarding the first magnitude of the persuasive power of the evaluator is higher, a greater weighting is given to the judgement by the evaluator, and the evaluation analysis part stores as a second rating data regarding the magnitude of the persuasive power of the evaluator in the evaluator rating data storage part in association with the identifier of each evaluator.

[20]

The online server for evaluation according to [18] or [19], wherein

the evaluation analysis data storage part is configured to store a pre-weighted evaluation distribution for the evaluation target;

the evaluation analysis part is configured to calculate the pre-weighted evaluation distribution for the evaluation target for each evaluation axis based on the evaluation input by each evaluator in the selective evaluation input section in the evaluation data stored in the evaluation data storage part, and to store the pre-weighted evaluation distribution in the evaluation analysis data storage part for each evaluation axis; and the evaluation analysis data extraction part is configured to extract an evaluation analysis data including the pre-weighted evaluation distribution itself and/or the statistics calculated based on the evaluation distribution stored in the evaluation analysis data storage part, and to transmit the evaluation analysis data from the transceiver to the administrator terminal via the network.

[21]

The online server for evaluation according to any one of [18] to [20], wherein

The evaluation analysis part is configured to calculate a first aggregated score of the evaluation of the evaluation target for each evaluation axis based on the evaluation input by each evaluator in the selective evaluation input section in the evaluation data stored in the evaluation data storage part, and to store the first aggregated score in the evaluation analysis data storage part for each evaluation axis,

and the evaluation analysis part is configured to calculate a second aggregated score of the evaluation of the evaluation target for each evaluation axis, based on the evaluation input by each evaluator in the selective evaluation input section in the evaluation data stored in the evaluation data storage part and the rating regarding the magnitude of the persuasive power of each evaluator stored in the evaluator rating data storage part, provided that as the rating regarding the magnitude of the persuasive power of the evaluator is higher, a greater weighting is given to the evaluation by the evaluator, and to store the second aggregated score in the evaluation analysis data storage part for each evaluation axis; and

the evaluation analysis data extraction part is configured to extract an evaluation analysis data including the first aggregated score and the second aggregated score stored in the evaluation analysis data storage part and transmit the evaluation analysis data from the transceiver to the administrator terminal via the network.

[22]

The online server for evaluation according to [21], wherein

the evaluation analysis part is configured to aggregate a score fluctuation risk for each evaluation axis based on a magnitude of a difference between the evaluation input by each evaluator in the selective evaluation input section in the evaluation data stored in the evaluation data storage part and the second aggregated score in the evaluation analysis data stored in the evaluation analysis data storage part, and based on the rating regarding the magnitude the persuasive power of each evaluator stored in the evaluator rating data storage part, provided that as the rating regarding the magnitude of the persuasive power of the evaluator is higher, a greater weighting is given to the evaluation by the evaluator when aggregating the score fluctuation risk, and the evaluation analysis part is configured to store the score fluctuation risk in the evaluation analysis data storage part; and

the evaluation analysis data extraction part is configured to extract an evaluation analysis data including the score fluctuation risk stored in the evaluation analysis data storage part and to transmit the evaluation analysis data from the transceiver to the administrator terminal via the network.

[23]

The online server for evaluation according to [21] or [22], wherein

the evaluation analysis part is configured to compare the evaluation input by each evaluator in the selective evaluation input section in the evaluation data stored in the evaluation data storage part and the second aggregated score in the evaluation analysis data stored in the evaluation analysis data storage part, and provided that a higher rating is given as proximity between them is higher, the evaluation analysis part is configured to rank a magnitude of a connoisseurship of each evaluator for each evaluation axis, and to store a rating data regarding the magnitude of the connoisseurship of the evaluator in the evaluator rating data storage part in association with the identifier of each evaluator; and

the evaluation analysis data extraction part is configured to extract the rating data regarding the magnitude of the connoisseurship of the evaluator stored in the evaluator rating data storage part for each evaluator and to transmit the rating data from the transceiver to the administrator terminal via the network.

[24]

The online server for evaluation according to any one of [21] to [23], wherein

the evaluation analysis part is configured to calculate a first comprehensive evaluation score for the evaluation target based on the first aggregated score for each evaluation axis in the evaluation analysis data stored in the evaluation analysis data storage part, and store the first comprehensive evaluation score in the evaluation analysis data storage part,

and the evaluation analysis part is configured to calculate a second comprehensive evaluation score for the evaluation target based on the second aggregated score for each evaluation axis in the evaluation analysis data stored in the evaluation analysis data storage part, and to store the second comprehensive evaluation score in the evaluation analysis data storage part; and

the evaluation analysis data extraction part is configured to extract an evaluation analysis data including the first comprehensive evaluation score and the second comprehensive evaluation score stored in the evaluation analysis data storage part and to transmit the evaluation analysis data from the transceiver to the administrator terminal via the network.

[25]

The online server for evaluation according to [24], wherein when the transceiver receives an instruction from the administrator terminal via the network to change a degree of influence of the aggregated score for each evaluation axis on the comprehensive evaluation score,

the evaluation analysis part is configured to change the degree of influence that the first aggregated score for each evaluation axis has on the first comprehensive evaluation score in response to the instruction to change the degree of influence, and to calculate a corrected first comprehensive evaluation score for the evaluation target based on the first aggregated score for each evaluation axis in the evaluation analysis data stored in the evaluation analysis data storage part, and to store the corrected first comprehensive evaluation score in the evaluation analysis data storage part,

and the evaluation analysis part is configured to change the degree of influence that the second aggregated score for each evaluation axis has on the second comprehensive evaluation score in response to the instruction to change the degree of influence, and to calculate a corrected second comprehensive evaluation score for the evaluation target based on the second aggregated score for each evaluation axis in the evaluation analysis data stored in the evaluation analysis data storage part, and to store the corrected second comprehensive evaluation score in the evaluation analysis data storage part; and

the evaluation analysis data extraction part is configured to transmit the corrected first comprehensive evaluation score and the corrected second comprehensive evaluation score from the transceiver to the administrator terminal via the network.

[26]

The online server for evaluation according to any one of [18] to [25], wherein when the at least one evaluation axis comprises at least one selected from the group consisting of growth potential of the evaluation target, stability of the evaluation target, and social contribution of the evaluation target.

[27]

The online server for evaluation according to any one of [18] to [26], wherein the at least one evaluation axis comprises two or more evaluation axes.

[28]

The online server for evaluation according to any one of [18] to [27], wherein the evaluation analysis data extraction part is configured to extract for each evaluator the rating data regarding the magnitude of the persuasive power of the evaluator stored in the evaluator rating data storage part, and to transmit the rating data from the transceiver to the administrator terminal via the network.

[29]

The online server for evaluation according to any one of [18] to [28], wherein the rating data regarding the magnitude of the persuasive power of the evaluator includes a relative score among the evaluators on the magnitude of the persuasive power.

[30]

The online server for evaluation according to any one of [18] to [29] wherein

the evaluation analysis part is configured to rank a magnitude of an explanatory power of each evaluator who has received the judgement for each evaluation axis, based on the judgement regarding the magnitude of the persuasive power of the evaluator input by each judge in the selective judgement input section in the judgement data stored in the judgement data storage part and based on a magnitude of a difference between the evaluation of the evaluation target input by the judge and the evaluation of the evaluation target input by the evaluator who has received the judgement from the judge in the evaluation data stored in the evaluation data storage part, provided that a higher rating is given as the magnitude of the persuasive power and the difference in the evaluation are greater, and the evaluation analysis part is configured to store as a rating data regarding the magnitude of the explanatory power of the evaluator in the evaluator rating data storage part in association with the identifier of each evaluator; and

the evaluation analysis data extraction part is configured to extract the rating data regarding the magnitude of the explanatory power of the evaluator stored in the evaluator rating data storage part for each evaluator and to transmit the rating data from the transceiver to the administrator terminal via the network.

[31]

The online server for evaluation according to any one of [18] to [31], wherein the evaluation analysis data extraction part is configured to extract for each evaluator the evaluation data including the evaluation input by each evaluator in the selective evaluation input section and the descriptive comment input section stored in the evaluation data storage part, and to transmit the evaluation data from the transceiver to the administrator terminal via the network.

[32]

The online server for evaluation according to any one of [18] to [31], wherein

the storage unit comprises a judge rating data storage part for storing a rating data regarding a magnitude of a connoisseurship of the judge in association with the identifier of each judge;

the evaluation analysis part is configured to compare the judgement regarding the magnitude of the persuasive power of the evaluator input by each judge in the selective judgement input section in the judgement data stored in the judgement data storage part and the rating regarding the magnitude of the persuasive power of the evaluator stored in the evaluator rating data storage part, and provided that a higher rating is given as proximity between them is higher, the evaluation analysis part is configured to rank the magnitude of the connoisseurship of each judge for each evaluation axis, and to store as a rating data regarding the magnitude of the connoisseurship of the judge in the judge rating data storage part in association with the identifier of each judge; and

the evaluation analysis data extraction part is configured to extract the rating data regarding the magnitude of the connoisseurship of the judge stored in the judge rating data storage part for each judge and to transmit the rating data from the transceiver to the administrator terminal via the network.

[33]

The online server for evaluation according to any one of [18] to [32], wherein the second format data further includes a selective evaluation re-input section for inputting a re-evaluation of the evaluation target for each evaluation axis, and the judgement data further includes a re-evaluation data including a re-evaluation of the evaluation target input by each judge in the selective evaluation re-input section.

[34]

The online server for evaluation according to [33], wherein the rating by the evaluation analysis part on the magnitude of the persuasive power of each evaluator who has received the judgement for each evaluation axis is performed based on the judgement regarding the magnitude of persuasive power of the evaluator input by each judge in the selective judgement input section in the judgement data stored in the judgement data storage part and on the re-evaluation input by each judge in the selective evaluation re-input section.

[35]

A program for causing a computer to execute the method for online evaluation according to any one of [1] to [17].

A computer-readable recording medium on which the program according to [35] is recorded.

According to one embodiment of the present invention, when performing an evaluation on an evaluation target, each evaluator goes through a process of determining a highly convincing evaluator based on the content of the evaluation itself rather than the identity of evaluator. Therefore, the evaluation target can be evaluated with high objectivity without being influenced by the power balance among the evaluators.

According to one embodiment of the present invention, the evaluation of the evaluation target is performed by a combination of a selective evaluation and a descriptive evaluation. Selective evaluation makes it easier to statistically analyze the evaluation data for the evaluation target. In addition, the descriptive evaluation allows to understand the way of thinking and the basis of the evaluation of the evaluators. Therefore, the evaluation regarding the persuasive power of the evaluators can be easily ranked by performing the descriptive evaluation. To know the way of thinking and basis of the evaluation of others is also effective in eliminating the asymmetry of information among evaluators. Further, the descriptive evaluation by the evaluators is useful information for rating the magnitude of the persuasive power, and as a result of the judgement of the magnitude of the persuasive power by the judge in a selective manner, statistical analysis of the rating data regarding the magnitude of the persuasive power becomes easy.

By combining the evaluation data for the above evaluation target with the rating data regarding the magnitude of the persuasive power, the overall evaluation of the evaluation target, which reflects the evaluation by the evaluators with objectively high persuasive power, can be obtained in a state where it is statistically easy to analyze.

According to one embodiment of the present invention, since the evaluation target is evaluated based on a plurality of evaluation axes, the evaluation of the evaluation target can be aggregated for each evaluation axis. It is also possible to perform a comprehensive evaluation that summarizes the evaluations based on the plurality of evaluation axes.

According to one embodiment of the present invention, when performing a comprehensive evaluation, the degree of influence of the score for each evaluation axis on the comprehensive evaluation score can be changed. Therefore, it is possible to obtain a flexible evaluation result according to the case and the evaluation purpose.

According to one embodiment of the present invention, it is possible to compare the overall evaluation of the evaluation target with the evaluation by a highly ranked evaluator regarding the magnitude of persuasive power, so it is possible to analyze the risk that the evaluation of the evaluation target fluctuates.

According to one embodiment of the present invention, it is possible to compare the overall evaluation of the evaluation target with the evaluation by each evaluator, so that evaluators with high connoisseurship can be analyzed.

According to one embodiment of the present invention, it is possible to easily specify evaluators with a high persuasive power, and it is possible to easily specify how such evaluators have made an evaluation of the evaluation target.

According to one embodiment of the present invention, it is also possible to measure the connoisseurship of judges who determine the magnitude of the persuasive power.

According to one embodiment of the present invention, an evaluator can re-evaluate the evaluation target after knowing the evaluation of the evaluation target by the other evaluators. Therefore, when the evaluation of the evaluation target by an evaluator is changed by the evaluation made by another evaluator, it can be used as a basis for showing that the other evaluator has a high persuasive power.

### BRIEF DESCRIPTION OF THE DRAWINGS

FIG. 1 shows an example of the overall configuration of an online evaluation system according to one embodiment of the present invention.

FIG. 2 shows a basic hardware configuration example of a server, a voter (evaluator, judge) terminal, an administrator terminal, and a server administrator terminal.

FIG. 3 shows an example of a functional block diagram of a server.

FIG. 4 is an example of a login screen displayed on a voter terminal.

FIG. 5 is an example of a menu screen of a voter page displayed on a voter terminal.

FIG. 6 is an example of a menu screen of an administrator page displayed on an administrator terminal.

FIG. 7 is an example of a condition setting screen for an evaluation session of an administrator page displayed on an administrator terminal.

FIG. 8-1 is an example a screen of an evaluation session of a page for evaluator displayed on a voter terminal.

FIG. 8-2 is another example a screen of an evaluation session of a page for evaluator displayed on a voter terminal.

FIG. 9-1 is an example a screen of a judgement session of a page for judge displayed on a voter terminal.

FIG. 9-2 is another example a screen of a judgement session of a page for judge displayed on a voter terminal.

FIG. 10 is an example of evaluation analysis data displayed on an administrator terminal.

FIG. 11 is another example of evaluation analysis data displayed on an administrator terminal.

FIG. 12 is yet another example of evaluation analysis data displayed on an administrator terminal.

FIG. 13 is yet another example of evaluation analysis data displayed on an administrator terminal.

FIG. 14 is yet another example of evaluation analysis data displayed on an administrator terminal.

FIG. 15 is yet another example of evaluation analysis data displayed on an administrator terminal.

FIG. 16 is yet another example of evaluation analysis data displayed on an administrator terminal.

FIG. 17 is an example of an administrator account information input screen of a server administrator page displayed on a server administrator terminal.

FIG. 18 is a flowchart of a process flow from an administrator accessing a server to register evaluators and inputting evaluation conditions to a screen for evaluation input on an evaluator terminal being displayed.

FIG. 19 is a flowchart showing a process flow from the start to the end of an evaluation session.

FIG. 20 is a flowchart showing a process flow from the start to the end of a judgement session.

FIG. 21 is a flowchart showing a process flow from the end of a judgement session through the evaluation analysis for the evaluation target by server 11 to the transmission of the result to the administrator terminal.

FIG. 22 is an example of a table in which the account information of one voter included in a voter account file is stored.

FIG. 23 is an example of a table in which information on evaluation conditions in an evaluation condition information file is stored.

FIG. 24 is an example of one table included in an evaluation data file.

FIG. 25 is an example of one table included in a judgement data file.

FIG. 26 is an example of one table included in an evaluator rating data file.

FIG. 27 is an example of one table included in an evaluation analysis data file.

FIG. 28 is an example of one table included in a judge rating data file.

FIG. 29 is an example of a table in which administrator account information in an administrator account file is stored.

FIG. 30 is an example of a table in which administrator account information in a server administrator account file is stored.

FIG. 31 is an example of a table in which the progress status included in a judgement progress management file is stored.

### DETAILED DESCRIPTION OF THE INVENTION

Hereinafter, embodiments of the method for online evaluation and the online server for evaluation according to the present invention will be described in detail with reference to the drawings, but the present invention is not limited to these embodiments. In the following description, a person who evaluates an evaluation target is referred to as an “evaluator”, and a person who judges the persuasive power of an evaluator is referred to as a “judge”. The evaluators and the judges are collectively referred to as voters. Voters who participate in the online evaluation are called evaluators when conducting an evaluation session, and are called judges when conducting a judgement session. An “evaluator terminal” refers to the terminal of the voter as an evaluator when conducting an evaluation session, and a “judgement terminal” refers to the terminal of the voter as a judge when conducting a judgement session.

<1. System Configuration>

FIG. 1 shows the overall configuration of the system for performing the method for online evaluation according to the present embodiment. This system comprises a server 11, a plurality of voter (evaluator, judge) terminals 12 from No. 1 to No. n, an administrator terminal 13, and a server administrator terminal 15. The voter (evaluator, judge) terminal 12, the administrator terminal 13, and the server administrator terminal 15 are connected to the server 11 in a communicable manner through a computer network 14 such as the Internet, a dedicated line, or a public network. The server administrator terminal 15 is not necessarily required to be a terminal independent of the server 11, and the server 11 can also take charge of the function of the server administrator terminal 15.

[Network]

The computer network 14 is not limited, but may be a wired network such as a LAN (Local Area Network) or a WAN (Wide Area Network), and may be a wireless network such as WLAN (Wireless Local Area Network) using MIMO (Multiple-Input Multiple-Output). Alternatively, it may be via the Internet using a communication protocol such as TCP/IP (Transmission Control Protocol/Internet Protocol), or via a base station (not shown) that plays a role as a so-called wireless LAN access point, or the like.

A server refers to a server computer, and can be configured by one computer or the cooperation of a plurality of computers. The voter terminal 12 and the administrator terminal 13 can be realized by a personal computer equipped with a browser, but the present invention is not limited to this, and they may be configured by devices/equipment allowing communication through a computer network such as a portable device such as a smartphone, a tablet, a cellphone, a mobile, a PDA, and furthermore, a digital TV.

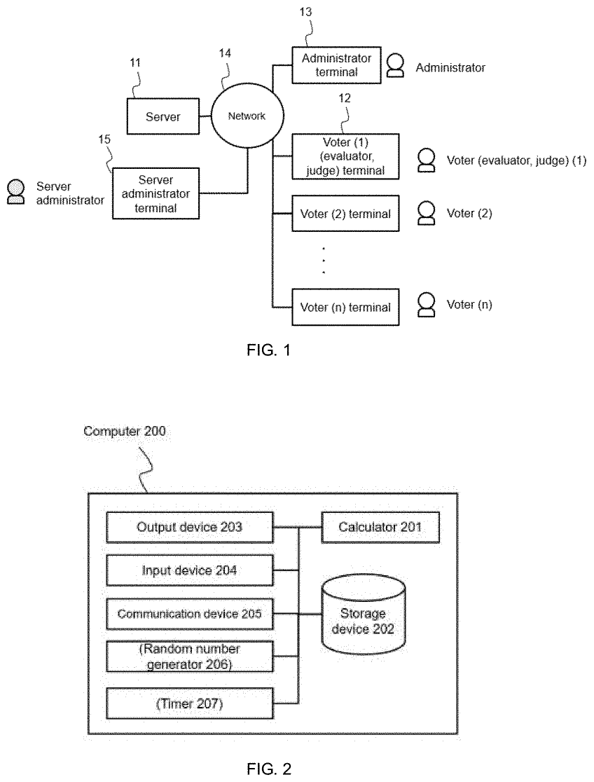

The basic hardware configurations of the server 11, the voter terminal 12, the administrator terminal 13, and the server administrator terminal 15 are common, and as shown in FIG. 2, they may be realized by a computer 200 comprising a calculator 201, a storage device 202, an output device 203, an input device 204, and a communication device 205. Further, a random number generator 206 and a timer 207 may be provided as needed.

The calculator 201 refers to a device, a circuit and the like that controls the entire computer and performs computation according to a program based on commands, instructions and data input by the input device 204 as well as data stored in the storage device 202, and the like. As the calculator 201, CPUs (Central Processing Units), MPUs (Micro Processing Units) and the like may be adopted.

The storage device 202 refers to a device, a circuit and the like storing various forms of data, the operating system (OS), the network application (for example. A web server software on the side of the server 11, browsers for the voter terminal 12, the administrator terminal 13 and the server administrator terminal 15) and programs for performing various computation. For example, known storage devices such as a primary storage device mainly employing a semiconductor memory, a secondary (auxiliary) storage device mainly employing a hard disk and a semiconductor disk, an offline storage device mainly employing a removable media drive like CD-ROM, and a tape library may be used. More specifically, in addition to magnetic memory storage devices such as hard-disk drives, Floppy™ disks drives, zip drives and tape storages, storage devices or storage circuits employing semiconductor memory such as registers, cache memory, ROM, RAM, flash memory (such as USB storage devices or solid state drive), semiconductor disks (such as RAM disks and virtual disk), optical storage media such as CDs and DVDs, optical storage devices employing magneto-optical disks like MO, other storage devices such as paper tapes and punch cards, storage devices employing phase change memory technique called PRAM (phase change RAM), holographic memory, storage devices employing 3-dimensional optical memory, storage devices employing molecular memory which stores information through accumulating electrical charge at the molecular level, and the like may all be used.

The output device 203 refers to an interface of a device, circuit or the like that enables output of data or commands. As the output device 203, a display such as LCD and OEL as well as a printer and a speaker, and the like can be employed.

The input device 204 refers to an interface to transmit data or commands to the calculator 201. As the input device 204, a keyboard, a numeric keypad, a pointing device such as a mouse, a touch panel, a reader (OCR), an input screen and an audio input interface such as a microphone may be employed.

The communicating device 205 refers to a device and a circuit for transmitting and receiving data to/from the outside the computer. The communicating device 205 may be an interface for connecting to the network such as a LAN port, a modem, wireless LAN and a router. The communicating device 205 can send or receive the computation results by the calculator 201 and the information stored in the storage device 202 via the computer network 14.

The random number generator 206 is a device which is able to provide random numbers.

The timer 207 is a device which is able to measure and inform time.

[Server]

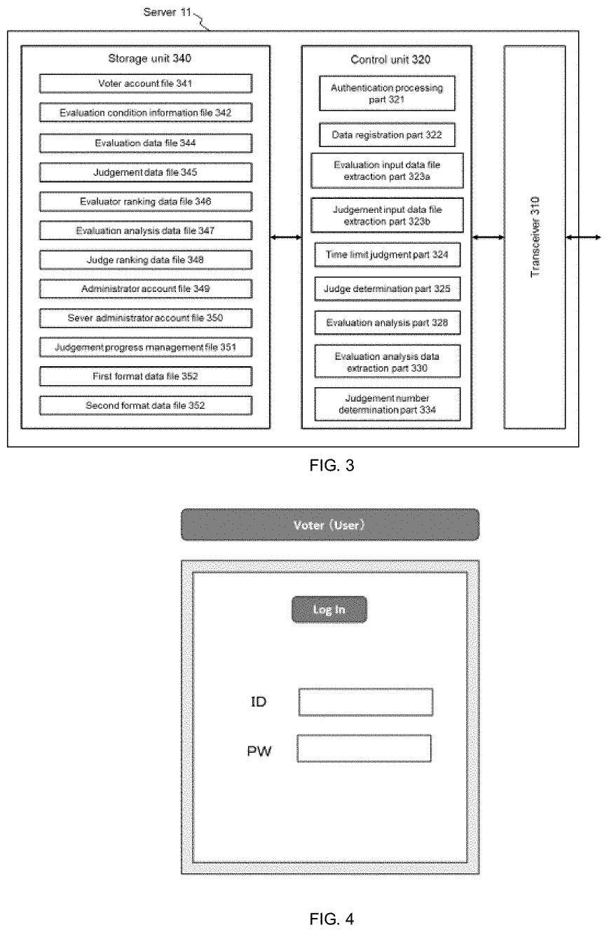

FIG. 3 shows an example of a functional block diagram of the server 11. The server 11 comprises a transceiver 310, a control unit 320 and a storage unit 340.

<Storage Unit>

The storage unit 340 of the server 11 may store a voter account file 341, an evaluation condition information file 342, an evaluation data file 344, a judgement data file 345, an evaluator rating data file 346, an evaluation analysis data file 347, a judge rating data file 348, an administrator account file 349, a server administrator account file 350, and a judgement progress management file 351. These files may be prepared individually according to the type of data, or a plurality of types of files may be collectively stored in one file.

Further, the storage unit 340 of the server 11 may store a first format data file 352 for evaluation input including a selective evaluation input section based on at least one evaluation axis and at least one descriptive comment input section, and a second format data file 353 including a selective judgement input section for inputting judgement regarding the magnitude of the persuasive power of the evaluator for each evaluation axis. These files may be prepared individually according to the type of data, or a plurality of types of data may be collectively stored in one file.

(Voter Account File)

In the voter account file 341, the account information of each voter who evaluates the evaluation target can be stored in a searchable manner. FIG. 22 shows an example of a table in which the account information of one voter included in a voter account file 341 is stored. The table may store the Individual ID of the voter, the voter ID, the organization ID of the organization to which the voter belongs, the ID within the organization such as employee number, the name, the Kana reading of the name, the email address, the department name, the date of birth, the zip code number, the address, the account opening date and time, the login password, the status, and the like. The status may include information on the progress of the evaluation, such as before evaluation, evaluating, and evaluation session completed.

(Evaluation Condition Information File)

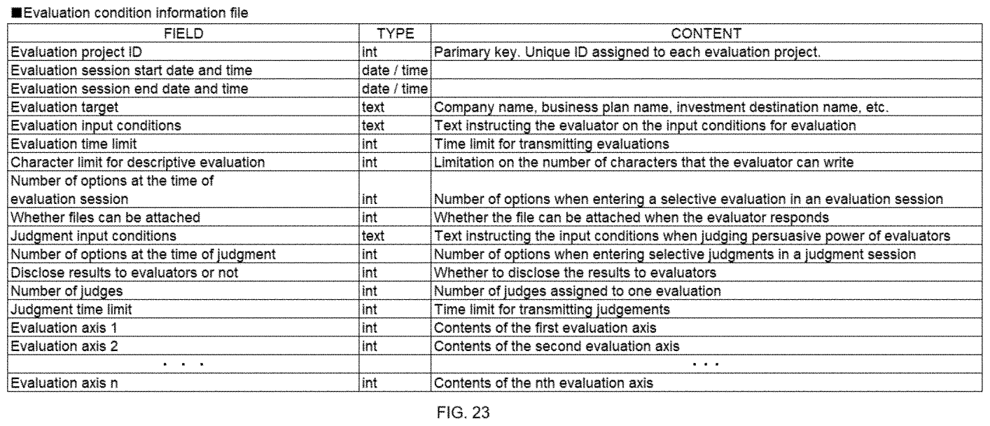

In the evaluation condition information file 342, information regarding the conditions for evaluating the evaluation target can be stored in a searchable manner. FIG. 23 shows an example of a table in which information on the evaluation conditions in the evaluation condition information file 342 is stored. Test conditions, such as the evaluation project ID, the evaluation session start date and time, the evaluation session end date and time, the information on the evaluation target, the evaluation input conditions, the evaluation time limit, the characteristic limit for descriptive evaluation, the number of options at the time of evaluation, the file attachment availability, the judgement input conditions, the number of options at the time of judgement, the necessity of disclosure of results to voters, the number of judges for one evaluation, the judgement time limit, the evaluation axes 1 to n (n is an integer of 1 or more), and the like may be stored. The number of judges for each evaluation is preferably large because more evaluations from judges can be collected, and the objectivity becomes higher. Therefore, the number of judges is preferably a plurality, more preferably 5 or more, and even more preferably 10 or more. However, a reasonable number of people (for example, in the range of 5 to 20) may be set in consideration of the test time and the number of judges.

In the evaluation condition information file 342, the information on the evaluation target can be stored in a searchable manner. The information on the evaluation target is not particularly limited as long as the information is sufficient to specify the evaluation target. For example, when evaluating company value, the name of the company, the name of the business plan, the name of the investee, or the like can be mentioned. Although not limited, other examples of evaluation targets include financial products, fashion, music, and the like.

The evaluation input conditions include, but are not limited to, the limit to the number of characters, the language, the character code, whether or not a file can be attached, the method of writing a descriptive evaluation comment, and the like.

At least one evaluation axis is necessary. In order to evaluate from various aspects, it is preferable there are two or more, and more preferably three or more evaluation axes. For example, when evaluating company value, the evaluation axis may include at least one, preferably two or more, and more preferably all the three selected from the group consisting of the growth potential of the evaluation target company, the stability of the evaluation target company, and the social contribution of the evaluation target company. Further, in addition to the evaluation axis for evaluating individual items, an evaluation axis for a comprehensive evaluation may be provided. This makes it possible to visualize “which evaluation axis has the greatest influence on the comprehensive evaluation” by performing a multiple regression analysis of the relationship between the evaluation of individual items of all evaluators and the comprehensive evaluation. However, as will be described later, the comprehensive evaluation can also be calculated from the evaluation results on each evaluation axis.

(Evaluation Data File)

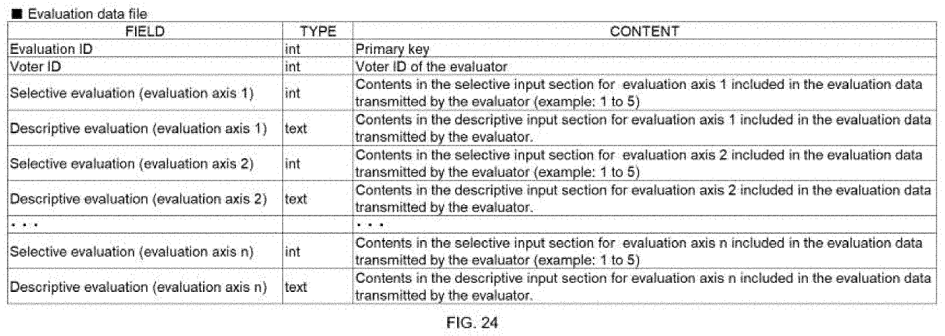

The evaluation data file 344 can store the evaluation data sent by the evaluator in a searchable manner. FIG. 24 shows an example of a table included in the evaluation data file 344. In the table, the evaluation ID which is an identifier of the evaluation data, the voter ID which is the identifier of the evaluator who has transmitted the evaluation data, the content of the selective evaluation, the content of the descriptive evaluation, and the like can be stored. The content of the selective evaluation and the content of the descriptive evaluation can be stored for each evaluation axis.

By performing evaluation of the evaluation target in combination of both selective evaluation and descriptive evaluation, it becomes easier to statistically analyze the evaluation data for the evaluation target by the selective evaluation, and at the same time, it is possible to understand the way of thinking and the basis of evaluation of the evaluator by the descriptive evaluation. In addition, since the descriptive evaluation is stored, the evaluation regarding the persuasive power of the evaluator to be carried out in a later stage can be easily performed. The selective evaluation may include, but not limited to, a method of selecting one of the options displayed in advance, a method of inputting a numerical value related to the magnitude of the evaluation, and the like.

(Judgement Data File)

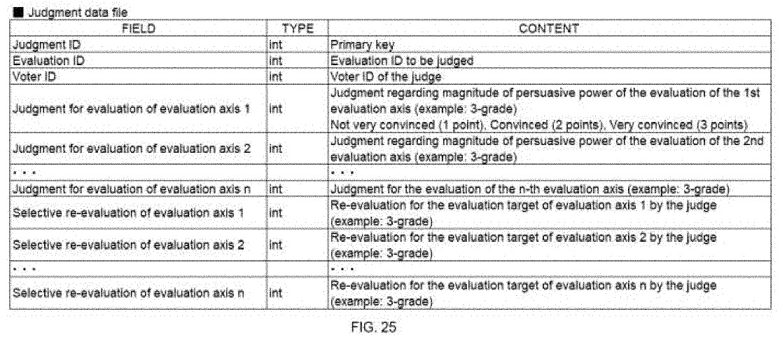

The judgement data file 345 can store the judgement data including the judgement on the persuasive power of the evaluator input by the judge in a searchable manner. FIG. 25 shows an example of a table included in the judgement data file 345. In the table, a judgement ID which is an identifier of the judgement data, an evaluation ID which is an identifier of the evaluation data to be judged, a voter ID of the judge, and a judgement value by the judge can be stored. For example, the judgement value may be a three-choice type such as “not very convinced”, “convinced”, or “very convinced”, or a two-choice type such as “convinced” or “not convinced”, or may be presented by scores within a predetermined range. The judgement value can be stored for each evaluation axis as described above.

The judgement data may further include a re-evaluation data including re-evaluation of the evaluation target input by each judge in the selective evaluation re-input section.

(Evaluator Rating Data File)

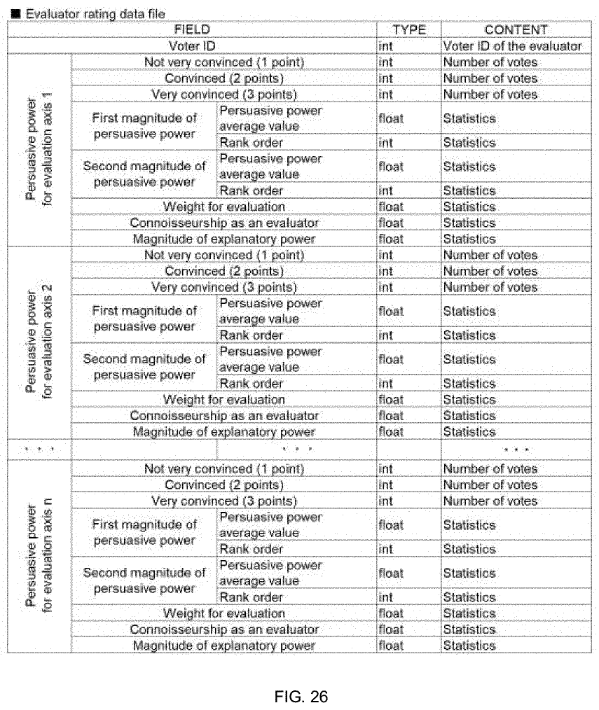

In the evaluator rating data file 346, a rating data regarding the persuasive power of the evaluator can be stored in a searchable manner. FIG. 26 shows an example of a table included in the evaluator rating data file 346. The table can store a voter ID which is the identifier of the evaluator, and a rating regarding the persuasive power of the evaluator. The rating can be performed based on, but not limited to, the judgement regarding the magnitude of persuasive power of the evaluator input by each judge in the selective judgement input section in the judgement data stored in the judgement data file. As used herein, the term “rating” includes both gradual and continuous rating for example, there is a method of calculating a weighted average of judgement from other judges for each evaluator and rating the evaluators in descending order of the rates. As the weighted average, for example, there is a method of calculating a score of the persuasive power as an evaluator for each judge, which is then standardized by dividing it by the sum of the scores of the persuasive power of all the judges such that the sum becomes 1, and using the standardized score as “weight” to weight the judgement of the judges and to calculate the average. In addition, another method includes giving a score regarding the persuasive power for each option, calculating the total score or the arithmetic mean score for each evaluator, and rating the evaluators in descending order of the total score or the arithmetic mean score.

(Evaluation Analysis Data File)

In the evaluation analysis data file 347, the pre-weighted evaluation distribution itself and/or the statistic calculated based on the pre-weighted evaluation distribution, and the weighted evaluation distribution itself and/or the statistic calculated based on the weighted evaluation distribution for the evaluation target can be stored for each evaluation axis in a searchable manner. The pre-weighted evaluation distribution can be calculated based on the evaluation input by each evaluator in the selective evaluation input section in the evaluation data stored in the evaluation data file. The weighted evaluation distribution is also calculated based on the evaluation input by each evaluator in the selective evaluation input section in the evaluation data stored in the evaluation data file. However, the weighted evaluation distribution is calculated by taking into account the rating regarding magnitude of the persuasive power of each evaluator stored in the evaluator rating data file, provided that as the rating regarding the magnitude of the persuasive power of the evaluator is higher, a greater weighting is given to the evaluation by the evaluator. As a result, the opinion of the evaluators judged to have a high persuasive power can be appropriately reflected.

Instead of reflecting the persuasive power of the evaluator in the evaluation result, it is also possible to consider a method in which the evaluators mutually judge the persuasive power, then re-evaluate the evaluation target, and present the result as the evaluation result. However, it has been empirically found that each evaluator has pride and tends to hesitate to change his or her evaluation by admitting that other evaluators are superior to himself or herself. Therefore, in the present invention, by using the parameter “persuasive power”, a situation where each evaluator can easily synchronize with other evaluators is created when the evaluation contents made by other evaluators are good.

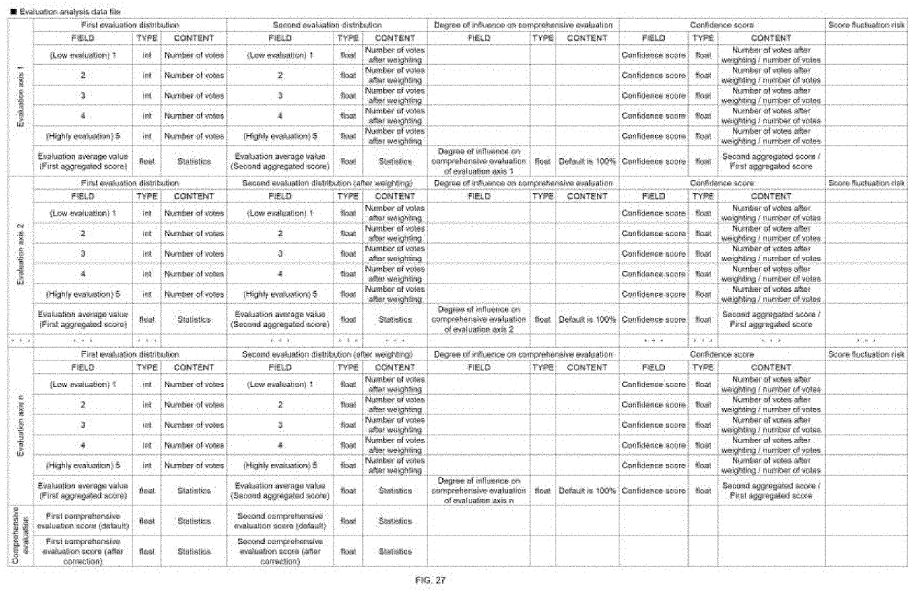

FIG. 27 shows an example of a table included in the evaluation analysis data file 347. In the column of the pre-weighted evaluation distribution of the table, the number of evaluators for each evaluation value input by each evaluator in the selective evaluation input section can be stored. In the column of the weighted evaluation distribution of the table, the number of evaluators for each evaluation value input by each evaluator in the selective evaluation input section after weighting can be stored, provided that as the rating regarding the magnitude of the persuasive power of the evaluator is higher, a greater weighting is given to the evaluation by the evaluator. Specific examples of weighting will be described later. The pre-weighted evaluation distribution and the weighted evaluation distribution can be stored for each evaluation axis.

(Judge Rating Data File)

In the judge rating data file 348, a rating data regarding the magnitude of the connoisseurship of the judges can be stored in a searchable manner. The connoisseurship of a judge means the accuracy when the judge makes a judgement regarding the magnitude of the persuasive power of other evaluators. Judgement regarding the magnitude of the persuasive power of the evaluator input by each judge in the selective judgement input section in the judgement data stored in the judgement data file is compared with the rating regarding the magnitude of the persuasive power of the evaluator stored in the evaluator rating data file, and the higher the proximity between the two is, the higher the connoisseurship is ranked.

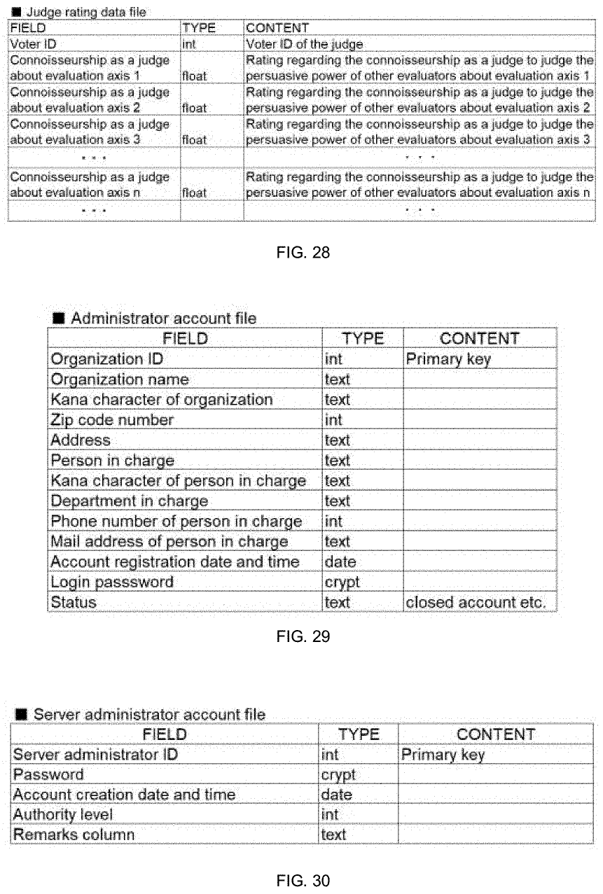

FIG. 28 shows an example of a table included in the judge rating data file 348. In the table, the voter ID which is an identifier of the judge, and the rating of the connoisseurship as a judge who judges the persuasive power of other evaluators can be stored for each evaluation axis.

(Administrator Account File)

In the administrator account file 349, the account information of an administrator, for example, an organization such as a company to which a voter belongs, can be stored in a searchable manner. FIG. 29 shows an example of a table in which the administrator account information in the administrator account file is stored. When the administrator is an organization such as a company, the table can store the organization ID, the organization name, the Kana character of the organization name, the zip code number and address of the organization, the department name in charge, the Kana reading, the phone number, and the email address of the person in charge, the account registration date and time, the login password, the status, and the like. The status may include information on the existence of the administrator account, such as “closed account”.

(Server Administrator Account File)

In the server administrator account file 350, the server administrator account information can be stored in a searchable manner. FIG. 30 shows an example of a table in which the administrator account information in the server administrator account file is stored. The table can store the server administrator ID, the password, the account creation date and time, the authority level, and the like.

(Judgement Progress Management File)

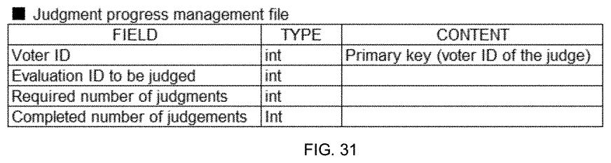

In the judgement progress management file 351, the information on the progress of the session for judging the persuasive power of the evaluators can be stored. FIG. 31 shows an example of a table in which the progress status included in the judgement progress management file 351 is stored. The voter ID of the judge, the evaluation ID to be evaluated by the judge, the required number of judgements, the number of completed judgements, and the like can be stored.

In the above tables in the data files, data types such as “int” (integers), “text” (character strings type), “float” (floating decimal numbers), “crypt” (encrypted strings) and “date” (date and time type) are used for each field. However, the data types are not limited to the illustrated form, but may be adjusted as necessary.

(First Format Data File)

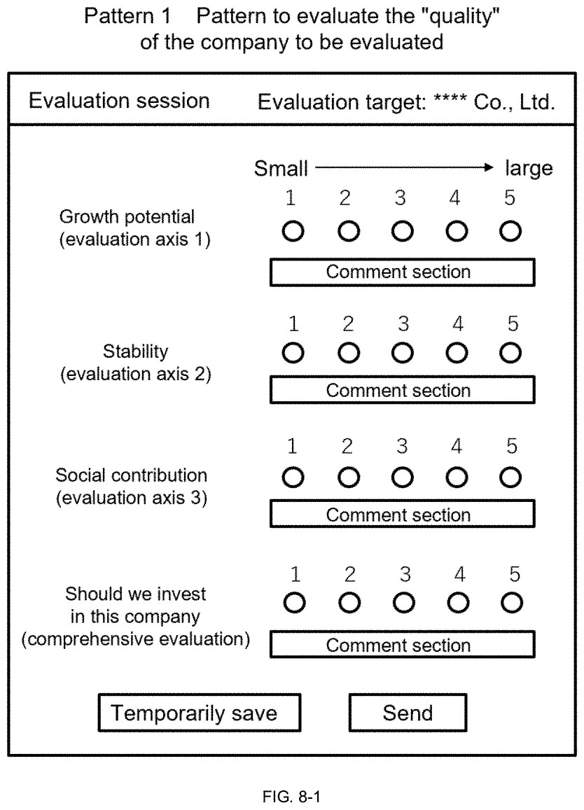

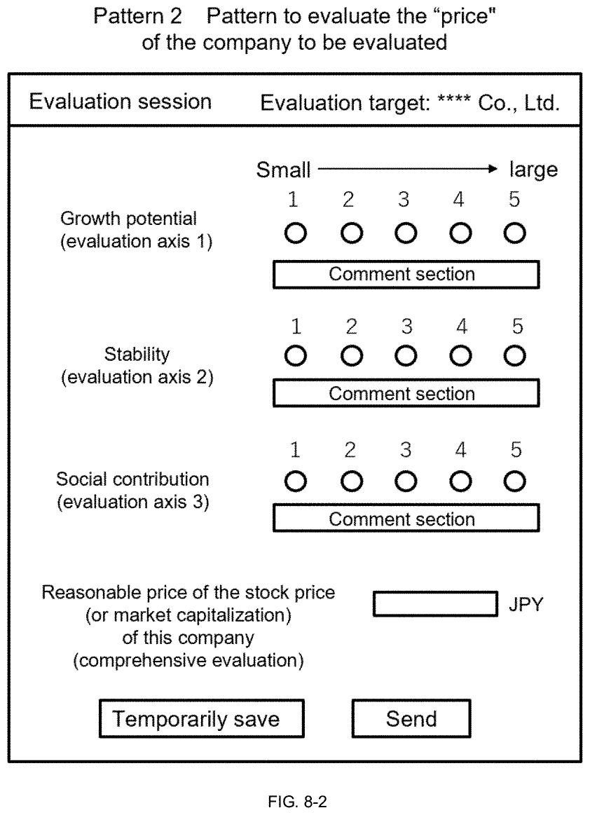

In the first format data file 352, a first format data for evaluation input including a selective evaluation input section based on at least one evaluation axis and at least one descriptive comment input section can be stored. As mentioned above, selective evaluation makes it easier to statistically analyze the evaluation data for the evaluation target. In addition, since the degree of freedom of description is increased by providing a descriptive evaluation, it is possible to deeply understand the way of thinking of the evaluator and the basis of the evaluation. Therefore, the evaluation regarding the persuasive power of the evaluator can be easily performed by evaluating in a descriptive manner. Knowing the way of thinking and the basis of the evaluation of others is also effective in eliminating the asymmetry of information among evaluators. FIGS. 8-1 and 8-2 show an example of a screen displayed based on the information on the evaluation target stored in the evaluation condition information file and the first format data for evaluation input. FIG. 8-1 is an example of a screen for evaluating the “quality” of the evaluation target company. FIG. 8-2 is an example of a screen when evaluating the “price” of the company to be evaluated.

(Second Format Data File)

In the second format data file 353, a second format data including a selective judgement input section for inputting judgement regarding a magnitude of the persuasive power for each evaluation axis can be stored. As mentioned above, the descriptive evaluation by the evaluators is useful information for rating the magnitude of the persuasive power, and as a result of the judgement of the magnitude of the persuasive power being made by the judge in a selective manner, the statistical analysis of the rating data regarding the persuasive power becomes easy. That is, as a result of the descriptive information here being converted into the selective information after being judged by the judges, statistical information analysis becomes easy.

The second format data may further include a selective evaluation re-input section for inputting a re-evaluation of the evaluation target for each evaluation axis. After reading the evaluation and comment of another evaluator, the evaluation by an evaluator for the evaluation target may change. In this case, since it means that the persuasive power of the other evaluator is high, it is useful information for rating the persuasive power of the evaluators.

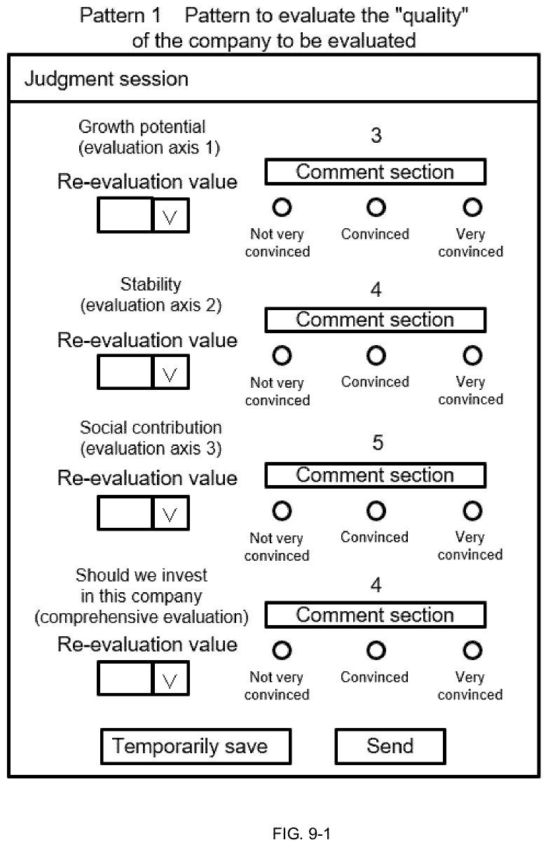

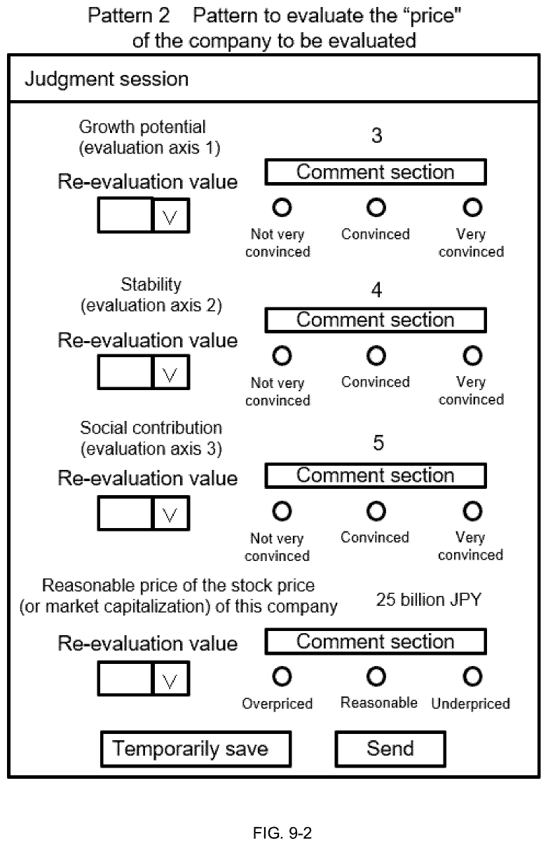

FIGS. 9-1 and 9-2 show an example of a screen displayed based on the second format data for inputting the judgement regarding the magnitude of persuasive power for each evaluation axis. FIG. 9-1 is an example of a screen for evaluating the “quality” of the evaluation target company. FIG. 9-2 is an example of a screen when evaluating the “price” of the company to be evaluated. In either case, the evaluation of the evaluation target input by the evaluators in the selective evaluation input section and the descriptive comment input section is expressed (here, a 5-grade evaluation and a comment column are displayed). However, it is not transmitted to the judge which evaluator the evaluation was made by. Since the anonymity of the evaluator is ensured, the judge can give an objective judgement result to the evaluation.

<Transceiver>

The server 11 can exchange various data through the transceiver 310 with the voter (evaluator, judge) terminal 12, the administrator terminal 13, and the server administrator terminal 15 via the computer network 14.

For example, the transceiver 310 may be configured to:
receive an instruction to start an evaluation session from the administrator terminal 13;
transmit information on the evaluation target and the first format data to each of the plurality of evaluator terminals 12 in the evaluation session in a displayable form;
receive an evaluation data including the evaluation of the evaluation target input by each evaluator in the selective evaluation input section and the descriptive comment input section from each evaluator terminal 12;
transmit an evaluation data including the evaluation to be judged by each judge and the second format data to the corresponding judge terminal 12 in a displayable form, in a manner in which the judge cannot identify the evaluator who has input the evaluation;
receive a judgement data including the judgement of the persuasive power of the evaluator input by each judge in the selective judgement input section from each judge terminal 12;
transmit various evaluation analysis data for the evaluation target to the administrator terminal 13 in a displayable form;
transmit a rating data regarding the magnitude of the connoisseurship of the judge to the administrator terminal 13 in a displayable manner;
   transmit a rating data regarding the magnitude of the persuasive power of the judge to the administrator terminal 13 in a displayable manner;
   transmit a rating data regarding the magnitude of the explanatory power of the judge to the administrator terminal 13 in a displayable manner;
   transmit an evaluation data including the evaluation input by each evaluator in the selective evaluation input section and the descriptive comment input section to the administrator terminal 13 in a displayable manner.

<Control Unit>

The control unit 320 of the server 11 comprises an authentication processing part 321, a data registration part 322, an evaluation input format extraction part 323a, a judgement input format extraction part 323b, a time limit judgement part 324, a judge determination part 325, an evaluation analysis part 328, an evaluation analysis data extraction part 330, and a Judgement number determination part 334. Each part can perform the desired calculation based on a program.

(Authentication Processing Part)

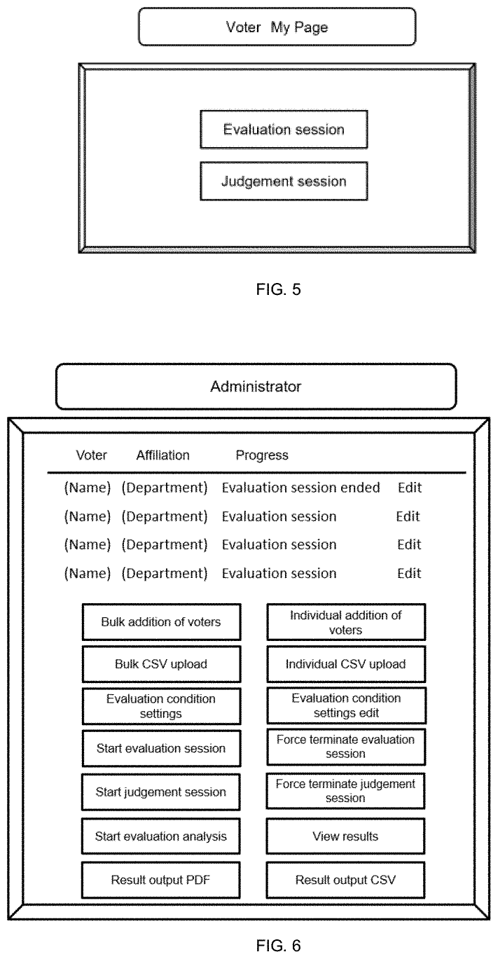

The authentication processing part 321 may authorize the voter ID and password based on an access request from the voter terminal 12. For example, the access request from the voter terminal 12 can be executed by inputting the voter ID and password and clicking a “Log In” button on a screen of a top page on the voter terminal 12 as shown in FIG. 4. The voter ID and password of each voter may be given in advance by the server administrator. The authentication processing may be executed by the authentication processing part 321 which can refer to the voter account data file 341 and determine whether or not the input voter ID and password match the data stored in the voter account data file 341. If the input voter ID and password match the stored data, the screen data of the voter page (for example, a menu screen shown in FIG. 5) can be transmitted from the transceiver 310 to the corresponding voter terminal 12. If not matching, an error message may be transmitted.

In addition, the authentication processing part 321 may authorize an organization ID and password based on an access request from the administrator terminal 13. The organization ID and password may be given in advance by the server administrator. The authentication processing may be executed by the authentication processing part 321 which can refer to the administrator account data file 349 and determine whether or not the input organization ID and password match the data stored in the administrator account data file 349. If the input organization ID and password match the stored data, the screen data of the administrator page such as that shown in FIG. 6 can be transmitted from the transceiver 310 to the corresponding administrator terminal 13. If not matching, an error message may be transmitted.

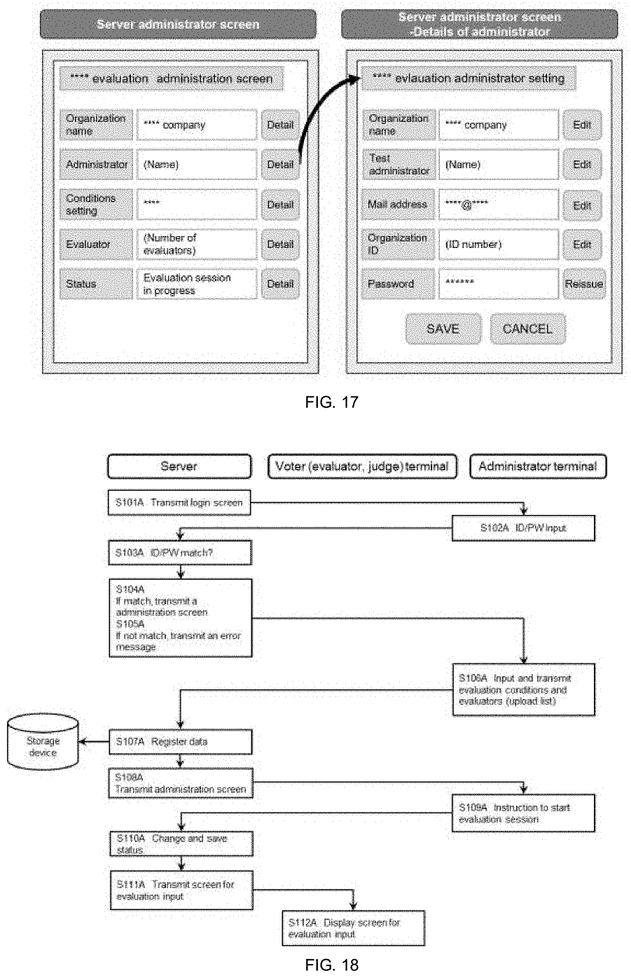

In addition, the authentication processing part 321 may authorize the server administrator ID and password based on an access request from the server administrator terminal 15. The server administrator ID and password may be given in advance by himself/herself. The authentication processing may be executed by the authentication processing part 321 which can refer to the server administrator account data file 350 and determine whether or not the input server administrator ID and password match the data stored in the server administrator account data file 350. If the input server administrator ID and password match the stored data, the screen data of the server administrator page (for example, the administration screen shown in FIG. 17) can be transmitted from the transceiver 310 to the corresponding server administrator terminal 15. If not matching, an error message may be transmitted.

(Data Registration Part)

The data registration part 322 may register the voters. For example, when the administrator such as a company to which the voters belong logins using the administrator terminal 13 according to the above procedures, an administrator screen as shown in FIG. 6 will be displayed on the administrator terminal 13. When the administrator clicks a button of “Bulk addition of voters” or a button of “Individual addition of voters”, a screen for inputting the voter account information (not shown) will be displayed on the administrator terminal 13, and on this screen, the predetermined voter account information to be stored in the voter account data file 341 such as a voter's individual ID, a voter ID, an organization ID of the organization to which the voter belongs, and the employee number. Once the input has been completed, by clicking a predetermined button such as “Save” or “Confirm” on this screen, the voter account information can be transmitted to the server 11. Alternatively, when the administrator clicks a button of “CSV bulk upload” or a button of “CSV individual Upload”, a screen for selecting a file saved in the administrator terminal 13 or the like is displayed, and by selecting the desired file in which the voter account information is stored and clicking a predetermined button such as “Transmit”, the voter account information can be transmitted to the server 11. In this way, the transceiver 310 in the server 11 can receive the voter account information transmitted to the server 11, and the data registration part 322 can store the received information in the voter account data file 341.

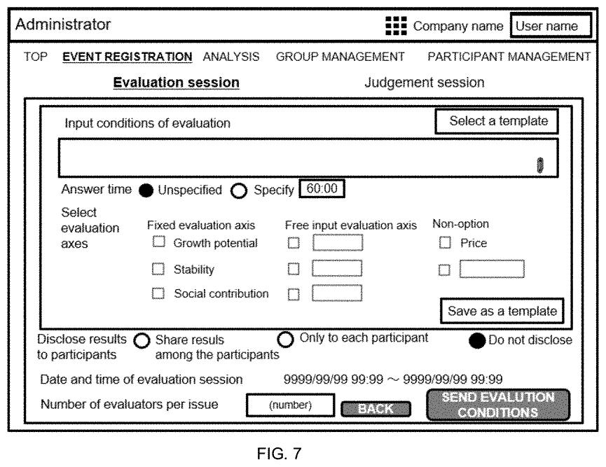

In addition, the data registration part 322 may register the conditions for evaluation. For example, when the administrator clicks a button of “Evaluation condition settings” on an administrator screen such as that shown in FIG. 6, the screen will be shift to a screen of condition settings for the evaluation session such as that shown in FIG. 7. On this screen, the administrator can input information to be stored in the evaluation condition data file 342 such as the information on the evaluation target, the information on input conditions for evaluation, the date and time of evaluation session, the evaluation time limit, the limit to the number of characters for descriptive evaluation, the number of options at the time of evaluation, the file attachment availability, the content of each evaluation axis, and the like. The evaluation conditions may be selectable from templates which are prepared in advance. Once input has been completed, by clicking a button of “Send evaluation conditions”, the evaluation conditions can be transmitted to the server 11. In this way, the transceiver 310 in the server 11 can receive the information on the evaluation conditions transmitted to the server 11, and the data registration part 322 can store the received information together with the evaluation project ID in the evaluation condition information file 342. The evaluation project ID may be manually input by the server administrator individually, or may be automatically assigned according to a predetermined rule when the evaluation condition information is stored in the data registration part 322 by the server 11. The administrator can also set conditions on an administration screen (not shown) in the judgement session such as judgement input conditions, the number of options at the time of judgement, and the judgement time limit.

Further, the data registration part 322 may register the administrators. When the server administrator (that is, the provider of the online evaluation system) logins using the server administrator terminal 15 according to the above procedures, a server administrator screen as shown on the left side in FIG. 17 will be displayed on the server administrator terminal 15. When the server administrator clicks the “Detail” button corresponding to the item desired to be set, a screen to input the administrator account information on the administrator of the organization as shown on the right side in FIG. 17 will be displayed on the server administrator terminal 15, and on this screen, the predetermined administrator account information to be stored in the administrator account data file 349 such as the organization ID, the person in charge, the contact information. Once input has been completed, by clicking the “Save” button, the administrator account information can be transmitted to the server 11. In this way, the transceiver 310 in the server 11 can receive the administrator account information transmitted to the server 11, and the data registration part 322 can store the received information in the administrator account data file 349.

Further, the data registration part 322 may register the evaluation by the evaluators of the evaluation target. For example, when a screen for evaluator in the evaluation session such as those shown in FIG. 8-1 or FIG. 8-2 is displayed on the evaluator terminal 12, if the evaluator inputs a selective evaluation or a descriptive evaluation and clicks the “Send” button, the evaluation data from this evaluator is transmitted to the server 11 via the computer network 14. When the time limit judgement part 324 judges that the evaluation received by the transceiver 310 is received within the time limit, the data registration part 322 may assign an evaluation ID to the evaluation data, and the evaluation data may be stored in the evaluation data file 344 in association with the voter ID of the evaluator who has transmitted the evaluation data, and the like.

Further, the data registration part 322 may register the judgement by the judges. For example, when a screen for judge in the judgement session as those shown in FIG. 9-1 or FIG. 9-2 is displayed on the judge terminal 12, if the judge selectively inputs the judgement of the persuasive power of the evaluator for each evaluation axis (here, clicking one of the buttons “Not very convinced”, “Convinced”, or “Very convinced” button indicating the convinced level of the judge) and clicks the “Send” button, the judgement data from this judge is transmitted to the server 11 via the computer network 14. When the judgement data is received by the transceiver 310, the data registration part 322 may assign a judgement ID to the judgement data, and the judgement data may be stored in the judgement data file 345 in association with the voter ID of the judge who has transmitted the judgement data and the evaluation ID, and the like. In the judgement session, similar to the evaluation session, the judgement data may be stored in the judgement data file 345 only when the time limit judgement part 324 judges that the data has been received within the time limit.

(Evaluation Input Data Extraction Part)

When the transceiver 310 receives the instruction to start the evaluation session from the administrator terminal 13, the evaluation input data extraction part 323a may collectively or individually transmit the first format data stored in the first format data file 352 from the transceiver 310 to each of the evaluator terminals 12 in a displayable form via the computer network 14. At this time, the evaluation input data extraction part 323a can transmit a predetermined evaluation condition such as the information on the evaluation target in the evaluation condition information file 342 in a displayable form together with the first format data. Further, when the instruction to start the evaluation session transmitted is received from the administrator terminal 13, the evaluation input data extraction part 323a can change the status in the voter account file 341 or the like to a status indicating that the evaluation session has started and store the status.

(Time Limit Judgement Part)

The time limit judgement part 324 may, for example, in the evaluation session, use the timer 207 which is built in the server 11 to judge whether or not the time when the transceiver 310 has received the evaluation data transmitted from the evaluator terminal 12 is within the time limit, based on the evaluation project ID, and the time information such as the evaluation session start date and time, the evaluation session end date and time, and evaluation time limit, which are stored in the evaluation condition information file 342.

As a result of the judgement, if it is judged that the time limit is met, the time limit judgement part 324 may instruct the data registration part 322 to assign an evaluation ID to the evaluation data, and to store it in the evaluation dada file 344 in association with the voter ID of the evaluator who has transmitted the evaluation data, and the like.

On the other hand, if it is judged that the time limit has passed, it is possible to refuse the transmission of the evaluation data from the evaluator terminal 12 or the reception by the server 11. Further regardless of whether or not an evaluation data is received from the evaluator terminal 12, when it is judged that the predetermined time limit has passed, the time limit judgement part 324 can transmit a message that the evaluation session has ended from the transceiver 310 to the evaluator terminal 12 and the administrator terminal 13 in a displayable form, and can refuse to receive the evaluation data beyond the time limit. Further, in order to record that the evaluation session has ended, the time limit judgement part 324 of the server 11 can change the status in the voter account file 341 and the like to “evaluation session ended”. Further, the time limit judgement part 324 may also transmit a message that the evaluation session has ended to the judge determination part 325.

(Judge Determination Part)

After it is confirmed that the evaluation session has ended, for example, because the status in the voter account file 341 or the like has turned to “evaluation session ended” for all the evaluators, or by receiving the message that the evaluation session has ended from the time limit judgement part 324, when the judge determination part 325 receives an instruction to start a judgement session transmitted from the administrator terminal 13 by the transceiver 310, and it can determine the judges who should judge the persuasive power of the evaluators in each evaluation data stored in the evaluation data file 344. Alternatively, when it is confirmed that the evaluation session has ended, for example, because the status in the voter account file 341 or the like has turned to “evaluation session ended” for all the evaluators, or by receiving the message that the evaluation session has ended from the time limit judgement part 324, the judge determination part 325 may automatically determine the judges who should evaluate the persuasive power of the evaluators in each evaluation data stored in the evaluation data file 344 without waiting for the instruction to start the judgement session transmitted from the administrator terminal 13. In this way, it is possible to save evaluation time.

The method of determining the judges may be performed according to a predetermined method, and there is no particular limitation. However, for example, all the evaluators may judge the persuasive power of all the evaluators other than himself/herself (round robin mutual evaluation). If the number of the evaluators is large, the evaluators may be divided into a plurality of groups and each group may perform a round robin mutual evaluation. Further, when the number of the evaluators is large, in order to suppress burden of each evaluator due to the mutual evaluation, random numbers generated from the random number generator 206 built in the server 11 may be obtained, and the random numbers may be used to determine judges who should judge the persuasive power of the evaluators in each evaluation data stored in the evaluation data file 344 (random shuffle mutual evaluation). When performing a random shuffle mutual evaluation, the judge determination part 325 can determine which judge should judge the persuasive power of which evaluator by using the random numbers to allocate a required number of voter IDs of the judges for the judgement to each evaluation ID from the voter IDs of all the evaluators.

When the judges who should judge the persuasive power of each evaluator is decided, for each judge, the judge determination part 325 can store the judgement ID, the evaluation ID for which the persuasive power should be judged, the required number of judgements, the completed number of judgements, and the like in association with each other in a judgement progress management file 351 for managing the progress of judgement by the judges.

An example of the judge determination procedure by the judge determination part 325 will be described. The judge determination part 325 may count the total number of evaluation data for all the evaluators, and obtain the maximum number of evaluation data to be assigned to each judge by the following formula. The calculation result can be rounded up to an integer.

Maximum number of assignments=(total number of evaluations)×(number of judges for one evaluation)/(total number of evaluators)

The number of judges who should make judgement for one evaluation can follow the “number of judges to be assigned to one evaluation” stored in the evaluation condition information file 342.

It is preferable that the judge determination part 325 refers to the evaluation data file 344, and if the voter ID of the evaluator who has transmitted a certain evaluation and the voter ID of the judge who should judge the evaluation by this voter selected by random numbers match, it is preferable to cancel the selection and re-select by random numbers. Further, when a judge having a specific voter ID is selected a number of times exceeding the maximum number of assignments obtained above, it is preferable for the judge determination part 325 to cancel the selection and re-select by random numbers. When the number of judges is sufficient, by selecting the judges in this way, and by repeating the assignment once or multiple times, all the judges can be assigned (maximum number of assignments) or (maximum number of assignments−1) evaluations to judge.

Further, the judge determination part 325 can be configured to change the status in the voter account file 341 or the like to a status indicating that the judgement session has started at an appropriate timing such as when receiving the instruction to start the judgement session transmitted from the administrator terminal 13.

(Judgement Input Data Extraction Part)

According to the determination by the judge determination part 325 on the judges who should judge the persuasive power of the evaluator, the judgement input data extraction part 323b can extract the evaluation data including the evaluation to be judged by each judge, based on the evaluation ID and the voter ID of the judge stored in the judgement progress management file 351; and the judgement input data extraction part 323b can extract the second format data including the selective judgement input section for inputting judgement regarding the magnitude of the persuasive power for each evaluation axis from the second format data file 353, and transmit the evaluation data and the second format data from the transceiver to the corresponding judge terminal 12 via the computer network 14 in a displayable form, however, in a manner in which the judge cannot identify the evaluator who has input the evaluation. The evaluation data to be judged by each judge may be transmitted all at once, or may be divided and transmitted.

The manner in which the judge cannot identify the evaluator who has input the evaluation may be, for example, a manner in which information that can identify the identity of the evaluator, such as the name and voter ID of the evaluator, is not transmitted to the judge terminal.

(Judgement Number Determination Part)

When the server 11 receives a judgement data regarding the persuasive power of the evaluator from the judge, the Judgement number determination part 334 of the server 11 increases the number of judgements by one in the judgement progress management file 351 in association with the voter ID of the judge who has transmitted the judgement. The Judgement number determination part 334 can grasp the progress status of the judgement session of the judge by comparing the number of completed judgements with the required number of judgements. When the evaluation data is divided and transmitted to each judge, the Judgement number determination part 334 determines whether or not the judgements has reached the required number of judgements according to the determination mentioned earlier, and if it is determined that the required number of judgements has not been reached, the Judgement number determination part 334 can instruct to transmit the unjudged evaluation data together with the second format data from the transceiver 310 to each corresponding judge terminal 12 via the computer network 14 in a displayable form, however, in a manner in which the judge cannot identify the evaluator who has input the evaluation. When the judgement number determination part 334 determines that the number of completed judgements from a certain judge has reached the required number of judgements, it can transmit a completion screen of the judgement session and/or a progress information that the judgement session has ended from the transceiver 310 to the judge terminal 12 of the judge and the administrator terminal 13. At this time, in order to record that the judgement session has ended, the judgement number determination part 334 can change the status in the voter account file 341 or the like to “judgement session end”.

(Evaluation Analysis Part)

### <Calculation of Pre-Weighted Evaluation Distribution>

The evaluation analysis part 328 can calculate a pre-weighted evaluation distribution of the evaluation target for each evaluation axis based on the evaluation input by each evaluator in the selective evaluation input section in the evaluation data stored in the evaluation data file 344, and store the pre-weighted evaluation distribution in the evaluation analysis data file 347 for each evaluation axis. For example, as shown in FIG. 27, the evaluation analysis part 328 can calculate the number of votes for each evaluation option for the evaluation target and store it in the evaluation analysis data file 347. Further, the evaluation analysis part 328 may also give each option a predetermined score provided that a higher score is given as the evaluation becomes higher, and calculate various statistics (for example, arithmetic mean value, total value, coefficient of variation, standard deviation, and the like) based on the pre-weighted evaluation distribution and store them in the evaluation analysis data file 347. In one embodiment, the statistic may include a first aggregated score. As the aggregated score, a central value such as an arithmetic mean value can be mentioned.

### <Calculation of Magnitude of Persuasive Power>

Further, the evaluation analysis part 328 can rank the magnitude of the persuasive power of each evaluator who has received the judgement for each evaluation axis based on the judgement regarding the magnitude of the persuasive power of the evaluator input by each judge in the selective judgement input section in the judgement data stored in the judgement data file 345, and store as the rating data regarding the magnitude of the persuasive power of the evaluator in the evaluator rating data file 346 in association with the voter ID of each evaluator.

As a rating method, for example, as shown in FIG. 26, the evaluation analysis part 328 calculates the number of votes for each option related to the judgement for each evaluator, and gives predetermined scores to each option provided that a higher score is given as the persuasive power is greater. For example, if there are three choices, “not very convinced”, “convinced”, and “very convinced”, scores can be given in a manner in which not very convinced=1 point, convinced=2 points, very convinced=3 points. Further, the evaluation analysis part 328 may also calculate statistics regarding a central value such as a total value or an arithmetic mean value of points regarding the magnitude of the persuasive power, and store this as a judgement value regarding persuasive power in the evaluator rating data file 346 in association with the voter ID of each evaluator. Further, the evaluation analysis part 328 may also compare the judgement values regarding persuasive power among the evaluators, calculate the ranking (rating) of each evaluator regarding the persuasive power provided that as the judgement value regarding the persuasive power is higher, the rating of the evaluator is higher, and store it in the evaluator rating data file 346 in association with the voter ID of each evaluator.

The rating for the evaluator is calculated without knowing the connoisseurship of each judge. Therefore, even if the evaluator has a huge persuasive power, the judgement result regarding the magnitude of the persuasive power may vary among judges having good connoisseurship and judges not having good connoisseurship. Therefore, it is preferable to give weighting to the judgements rather than treating the judgements from all the judges equally. As a method of weighting the judgements, there can be mentioned a method in which the evaluation analysis part 328 performs a step in which: the evaluation analysis part 328 ranks a first magnitude of the persuasive power of each evaluator who has received the judgement for each evaluation axis based on the judgement regarding the magnitude of the persuasive power of the evaluator input by each judge in the selective judgement input section, and stores as a first rating data regarding the magnitude of the persuasive power of the evaluator in the evaluator rating data file 346 in association with the voter ID of each evaluator; followed by a step performed at least once in which the evaluation analysis part 328 ranks a second magnitude of the persuasive power of each evaluator who has received the judgement for each evaluation axis, based on the judgement regarding the persuasive power of the evaluator input by each judge in the selective judgement input section and the first rating data stored in the evaluator rating data file 346, provided that as the rating regarding the first magnitude of the persuasive power of the evaluator is higher, a greater weighting is given to the judgement by the evaluator, and the evaluation analysis part 328 stores as a second rating data regarding the magnitude of the persuasive power of the evaluator in the evaluator rating data file 346 in association with the voter ID of each evaluator. When the step is repeated a plurality of times, in the nth step, the “first magnitude of the persuasive power” and the “first rating data” are read as “nth magnitude of the persuasive power” and “nth rating data” and the “second magnitude of the persuasive power” and the “second rating data” are read as “n+1 magnitude of the persuasive power” and “n+1 rating data” (wherein n is a natural number). The method of weighting the judgements is not limited, but for example, the same method as the “method of weighting the evaluation” described later can be adopted.

This is a method based on the assumption that the evaluator who is judged to have high persuasive power also has high connoisseurship as a judge. In this way, the evaluation analysis part 328 makes a judgement on the magnitude of the persuasive power while giving weighting to judgements, and repeats the correction of the persuasive power ranking (rating) of each evaluator once or more, preferably 5 time s or more, more preferably 10 times or more based on the obtained rating, the judgements by the judges who appear to have high connoisseurship can be greatly reflected in the ranking (rating) regarding the persuasive power of each evaluator.

In addition, the evaluation analysis part 328 may rank the magnitude of the persuasive power of each evaluator who has received the judgement for each evaluation axis in consideration of the re-evaluation of the evaluation target input by each judge in the selective evaluation re-input section, in addition to the judgement regarding the magnitude of persuasive power of the evaluator input by each judge in the selective judgement input section in the judgement data stored in the judgement data file 345. For example, when the re-evaluation of the evaluation target by the judge is closer to the evaluation by the evaluator for the judgement target than the original evaluation of the evaluation target by the judge, the score regarding the persuasive power of the evaluator can be added by a predetermined score. The points to be added may be changed according to the number of judges who have changed the evaluation in sympathy with the evaluator.

<Calculation of Weighted Evaluation Distribution>

Further, the evaluation analysis part 328 can calculate a weighted evaluation distribution for the evaluation target for each evaluation axis, based on the evaluation input by each evaluator in the selective evaluation input section in the evaluation data stored in the evaluation data storage part and the rating regarding the magnitude of the persuasive power of each evaluator stored in the evaluator rating data file 346, provided that as the rating regarding the magnitude of the persuasive power of the evaluator is higher, a greater weighting is given to the evaluation by the evaluator, and the evaluation analysis part 328 can store the weighted evaluation distribution in an evaluation analysis data file 347 for each evaluation axis.

An example of a method of weighting the evaluations will be described. The evaluation analysis part 328 calculates the ratio of the arithmetic mean value of the score regarding the persuasive power of each evaluator to the arithmetic mean value of the score regarding the persuasive power of the entire evaluators for each evaluation axis, and gives a weighting factor (Weight) for each evaluator based on the ratio. The ratio itself can also be used as the weighting factor. In this case, for the evaluator whose arithmetic mean value of the score regarding the persuasive power is higher than the arithmetic mean value of the score regarding the persuasive power of the entire evaluators, the value of his/her vote is increased by weighting. On the other hand, for the evaluator whose arithmetic mean value of the score regarding the persuasive power is lower than the arithmetic mean value of the score regarding the persuasive power of the entire evaluators, the value of his/her vote is decreased by weighting. The weighting factor assigned to each evaluator can be, for example, stored in the evaluator rating data file 346 in association with the voter ID of each evaluator.

Another example of the method of weighting the evaluations will be described. Assuming that the total number of evaluators is N for each evaluation axis, the evaluation analysis part 328 gives weighting to the evaluations from the evaluator ranked kth (k=1 to N) regarding the persuasive power by the following formula.

Weight=1+sin {(1−2×(k−1)/(N−1))×pi/2}

By weighting in this way, the weighting factor (Weight) can be assigned to each evaluator for each evaluation axis. In this case, initially, the evaluation by each evaluator has the voting value of one vote equally, but the evaluation from the highest ranked evaluator is changed to have the voting value of 2 votes, and the evaluation from the lowest ranked evaluator is changed to have the voting value of 0 votes. Weighting may also be performed by a method different from the above.

After weighting, by correcting the number of votes for each option stored in the evaluation analysis data file 347 according to the calculation result of weighting, a weighted evaluation distribution is obtained. As an example, the number of votes for each option after weighting can be represented by the total weight (weight) of the evaluators who have voted for the option. The total weight is the sum of the weighting factor given to the evaluators who have voted for the option.

The evaluation analysis part 328 may also calculate various statistics (for example, arithmetic mean value, total value, coefficient of variation, standard deviation, etc.) based on the weighted evaluation distribution and store them in the evaluation analysis data file 347. For example, the evaluation analysis part 328 may calculate a second aggregated score (for example, a central value such as an arithmetic mean value) and store it in the evaluation analysis data file 347. Further, the evaluation analysis part 328 may calculate the ratio of the number of votes after weighting to the number of votes before weighting (herein referred to as “confidence score”) for each evaluation axis and stores it in the evaluation analysis data file 347. The confidence score becomes higher when the evaluators who are judged to have a higher persuasive power give a high evaluation to the evaluation target.

<Calculation of Score Fluctuation Risk>

The evaluation analysis part 328 can aggregate a score fluctuation risk for each evaluation axis based on a magnitude of a difference between the evaluation input by each evaluator in the selective evaluation input section in the evaluation data stored in the evaluation data file 344 and the second aggregated score in the evaluation analysis data stored in the evaluation analysis data file 347, and based on the rating regarding the magnitude the persuasive power of each evaluator stored in the evaluator rating data file 346, provided that as the rating regarding the magnitude of the persuasive power of the evaluator is higher, a greater weighting is given to the evaluation by the evaluator when aggregating the score fluctuation risk, and the evaluation analysis part 328 can store the score fluctuation risk in the evaluation analysis data file 347.

When the risk of score fluctuation is high, it means that the divergence of evaluation of the evaluation target is large between the highly rated evaluators regarding the magnitude of persuasive power and the entire evaluators. Therefore, it can be said that there is a high possibility that the evaluation of the evaluation target will change if the evaluation of the evaluation target is performed again.

<Calculation of Connoisseurship of Evaluators>

The evaluation analysis part 328 can compare the evaluation input by each evaluator in the selective evaluation input section in the evaluation data stored in the evaluation data file 344 and the second aggregated score in the evaluation analysis data stored in the evaluation analysis data file 347, and provided that a higher rating is given as proximity between them is higher, the evaluation analysis part 328 can rank a magnitude of a connoisseurship of each evaluator for each evaluation axis, and store a rating data regarding the magnitude of the connoisseurship of the evaluator in the evaluator rating data file 346 in association with the voter ID of each evaluator. If the evaluation analysis part 328 has this function, it is possible to find personnel having a high ability to appropriately evaluate the evaluation target.

<Calculation of Comprehensive Evaluation Score>

The evaluation analysis part 328 can calculate a first comprehensive evaluation score for the evaluation target based on the first aggregated score for each evaluation axis in the evaluation data stored in the evaluation data file 347 and store the first comprehensive evaluation score in the evaluation analysis data file 347. For example, the first comprehensive evaluation score may be the arithmetic mean value of the first aggregated score for each evaluation axis or a value based on this arithmetic mean value, and may be the total value of the first aggregated score for each evaluation axis or a value based on this total value.

Further, the evaluation analysis part 328 can also calculate a second comprehensive evaluation score for the evaluation target based on the second aggregated score for each evaluation axis in the evaluation analysis data stored in the evaluation analysis data file 347. For example, the second comprehensive evaluation score may be the arithmetic mean value of the second aggregated score for each evaluation axis or a value based on this arithmetic mean value, and may be the total value of the second aggregated scores for each evaluation axis or a value based on this total value.

When calculating the comprehensive evaluation score, the evaluation analysis part 328 may be configured to change the influence of the first aggregated score and the second aggregated score of each evaluation axis on the comprehensive evaluation score upon receiving an instruction to change the degree of influence of the aggregated score of each evaluation axis on the comprehensive evaluation score from the administrator terminal 13 via the computer network 14. The influence of the aggregated score of each evaluation axis on the comprehensive evaluation score is not constant and may fluctuate according to the case and evaluation purpose, and since the evaluation analysis part 328 has this function, it is possible to flexibly calculate the comprehensive evaluation score for the evaluation target.

For example, the evaluation analysis part 328 can change the degree of influence that the first aggregated score for each evaluation axis has on the first comprehensive evaluation score in response to the instruction to change the degree of influence, and then calculate a corrected first comprehensive evaluation score for the evaluation target based on the first aggregated score for each evaluation axis in the evaluation analysis data stored in the evaluation analysis data file 347, and store the corrected first comprehensive evaluation score in the evaluation analysis data file 347;

and the evaluation analysis part 328 can change the degree of influence that the second aggregated score for each evaluation axis has on the second comprehensive evaluation score in response to the instruction to change the degree of influence, and then calculate a corrected second comprehensive evaluation score for the evaluation target based on the second aggregated score for each evaluation axis in the evaluation analysis data stored in the evaluation analysis data file 347, and store the corrected second comprehensive evaluation score in the evaluation analysis data file 347.

As for the degree of influence, for example, the degree of influence of 0% to 100% is given to each evaluation axis, and the default is to set the degree of influence of all evaluation axes equal (example: 100%). In this case, for example, if there are three evaluation axes and the first (second) aggregated scores for evaluation axes are E1, E2, and E3, respectively, then the default first (second) comprehensive evaluation score can be the arithmetic mean value, which is (E1+E2+E3)/3. On the other hand, for example, if the degrees of influence of the three evaluation axes are changed to x %, y %, and z %, respectively, the corrected first (second) comprehensive evaluation score can be (E1×x %+E2×y %+E3×z %)/3.

<Rating of Explanatory Power of Evaluators>

The evaluation analysis part 328 can rank a magnitude of an explanatory power of each evaluator who has received the judgement for each evaluation axis, based on:

(1) the judgement regarding the magnitude of the persuasive power of the evaluator input by each judge in the selective judgement input section in the judgement data stored in the judgement data file 345; and
(2) a magnitude of a difference between the evaluation of the evaluation target input by the judge and the evaluation of the evaluation target input by the evaluator who has received the judgement from the judge in the evaluation data stored in the evaluation data file 344; provided that a higher rating is given as the magnitude of the persuasive power and the difference in the evaluation are bigger, and the evaluation analysis part 328 can store as a rating data regarding the magnitude of the explanatory power of the evaluator in the evaluator rating data file 346 in association with the voter ID of each evaluator. If the evaluation analysis part 328 has this function, it is possible to find personnel (influencers) with great explanatory power who can write comments sympathized by others and give awareness to others who have different opinions.

A specific example of a method of calculating the magnitude of the explanatory power of an evaluator to others will be described. In one embodiment, the magnitude of the explanatory power of the evaluator to others can be defined by the weighted average of (persuasive power score of the evaluator) x (a difference between the evaluation score for the evaluation target by the judge and the evaluation score for the evaluation target input by the evaluator who has received the judgement from the judge) for each evaluation axis.

<Calculation of Connoisseurship as Judge>

The evaluation analysis part 328 can compare the judgement regarding the magnitude of the persuasive power of the evaluator input by each judge in the selective judgement input section in the judgement data stored in the judgement data file 345 and the rating regarding the magnitude of the persuasive power of the evaluator stored in the evaluator rating data file 346, and provided that a higher rating is given as proximity between them is higher, the evaluation analysis part 328 can rank the magnitude of the connoisseurship of each judge for each evaluation axis, and store as a rating data regarding the magnitude of the connoisseurship of the judge in the judge rating data file 348 in association with the voter ID of each judge. If the evaluation analysis part 328 has this function, it is possible to find personnel having a high ability to appropriately judge the persuasive power of other evaluators.

A specific example of the method of calculating the connoisseurship as a judge will be described. The evaluation analysis part 328 compares the judgement regarding the magnitude of the persuasive power of an evaluator input by a certain judge in the selective judgement input section in the judgement data stored in the judgement data file 345 (for example, in a case of 3-grade evaluation, a number of 1 to 3) and the rating regarding the magnitude of the persuasive power of the evaluator stored in the evaluator rating data file 346 (for example, the average value of the second magnitude of the persuasive power) with respect to an evaluation axis n, and calculates the difference. In the same manner, the evaluation analysis part 328 calculates the difference between all the judgements regarding the persuasive power of evaluators input by the judge and the rating regarding the persuasive power of the corresponding evaluators with respect to the evaluation axis n. The evaluation analysis part 328 calculates the sum the differences or the average of the differences obtained in this way, and obtains basic data for rating the magnitude of the connoisseurship of the judge with respect to the evaluation axis n. In the same manner, the evaluation analysis part 328 obtains basic data for rating the magnitude of the connoisseurship with respect to the evaluation axis n for other judges.

The evaluation analysis part 328 ranks the magnitude of the connoisseurship of each judge with respect to the evaluation axis n, provided that as the sum of the differences or the average of the differences obtained in this way is smaller, a higher rating is given, and stores as a rating data regarding the magnitude of the connoisseurship of the judge in the judge rating data file 348 in association with the voter ID of each judge. The rating may be a rank order, or may be expressed by the calculated sum of the differences or the average of the differences itself, or by a parameter calculated based on the sum of the differences or the average of the differences.

(Evaluation analysis data extraction part)

The evaluation analysis data extraction part 330 can extract various evaluation analysis data stored in the evaluation analysis data file 347, and transmit the evaluation analysis data from the transceiver 310 to the administrator terminal 13 via the computer network 14 in a displayable form. Examples of the evaluation analysis data include one or more of the following.
Pre-weighted evaluation distribution and weighted evaluation distribution
First aggregated score and second aggregated score
Score fluctuation risk
Confidence score
First comprehensive evaluation score and second comprehensive evaluation score
Corrected first comprehensive evaluation score and corrected second comprehensive evaluation score

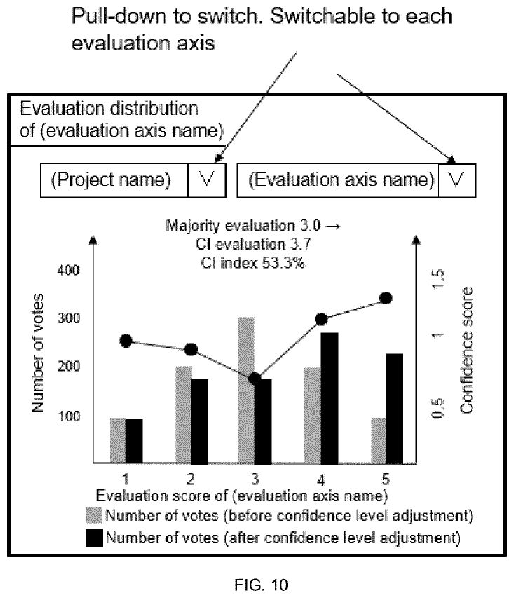

FIG. 10 shows an example of evaluation analysis data displayed on the administrator terminal 13. The number of votes for each option and the confidence score for a specific evaluation axis when the evaluation target is evaluated by a 5-grade evaluation are shown. In the figure, “project name” means the evaluation target. When there is a plurality of projects, a pull-down menu is displayed by clicking “Project”, so that the desired project can be selected. “Majority evaluation” refers to the first aggregated score, and “CI evaluation” refers to the second aggregated score. The term “CI index” means (CI evaluation-majority evaluation)/(standard deviation of evaluation distribution)×100(%). The CI index can be used as an index of learning effect or a return on investment by mutual evaluation among evaluators. “Number of votes (before confidence level adjustment)” refers to the pre-weighted evaluation distribution. “Number of votes (after confidence level adjustment)” refers to the weighted evaluation distribution. CI is an abbreviation for “Consensus Intelligence”.

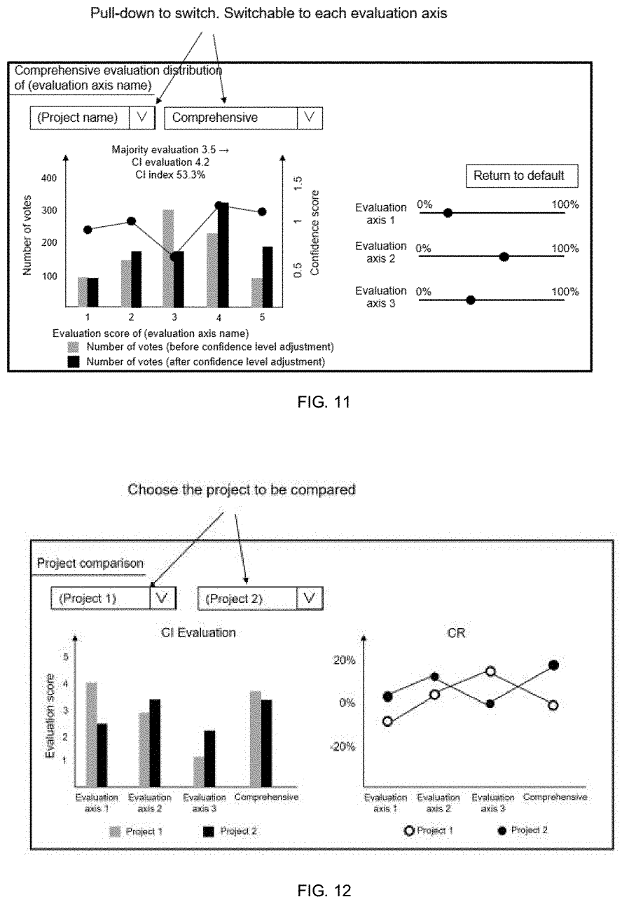

FIG. 11 shows another example of the evaluation analysis data displayed on the administrator terminal 13. The number of votes for each option and the confidence score for the comprehensive evaluation when the evaluation target is evaluated by a 5-grade evaluation based on three evaluation axes are shown. “Number of votes (before confidence level adjustment)” refers to the simple total number of votes for the three evaluation axes. “Number of votes (after confidence level adjustment)” refers to the total number of votes for the three evaluation axes based on the weighted evaluation distribution. Furthermore, by moving the slider on the screen, the degree of influence that each evaluation axis has on the comprehensive evaluation can be adjusted, so that the effect on the number of votes (after confidence level adjustment) can be simulated on the graph.

FIG. 12 shows yet another example of the evaluation analysis data displayed on the administrator terminal 13. The CI evaluation and CR (critical risk) when two evaluation targets are evaluated by a 5-grade evaluation based on three evaluation axes are shown on the same screen. This facilitates comparison of evaluation targets. The “CR (critical risk)” refers to the risk of score fluctuation.

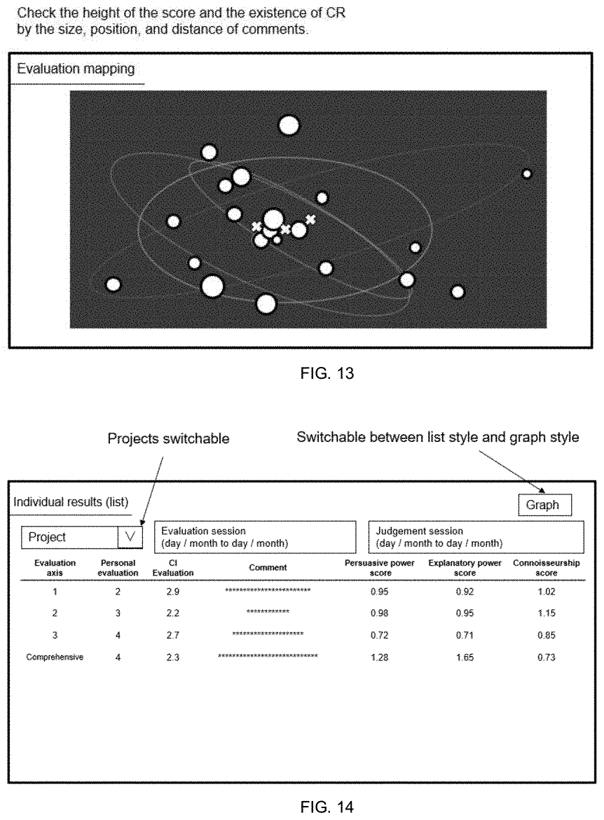

FIG. 13 shows yet another example of the evaluation analysis data displayed on the administrator terminal 13. In FIG. 13, based on the persuasive power for a plurality of evaluation axes of the content of the descriptive evaluation of the evaluation target by each evaluator (hereinafter referred to as “comment”), the comments by each evaluator are mapped such that the comments by each evaluator are aggregated into two new axes that can be separated so that they do not visually overlap.

An example of information that can be shown by the map of FIG. 13 will be described. In the map of FIG. 13, there are cross marks displayed by three types of filling methods. These are the respective positions of the comments made by three evaluators. In addition, there are circle marks that are displayed by the same type of filling method as the x mark. These are the positions of judgements made by the judges for the comments indicated by the respective cross marks. As the cross mark and the circle mark of the same type get closer, it indicates the persuasive power of the judge as an evaluator is closer to the persuasive power of the comment by the evaluator. In addition, the size of the circle marks indicates the degree of persuasive power of each judge as an evaluator, and as the size of the circle mark gets larger, it means the persuasive power of the judge as an evaluator is higher. The distance between the circle marks indicates the proximity of persuasive power among the judges. The presence of a large CR is suggested when there is a large circle mark away from the cross mark.

Another example of information that can be shown by the map of FIG. 13 will be described. In the map of FIG. 13, there are cross marks displayed by three types of filling methods. These are the respective positions of persuasive power of three judges as evaluators. In addition, there are circle marks that are displayed by the same type of filling method as the x mark. These are the positions of the evaluation comments judged by the judges indicated at the respective cross marks. As the cross mark and the circle mark of the same type get closer, it indicates the CR is smaller. In addition, the size of the circle mark indicates the magnitude of the persuasive power of the comment by the evaluator, and as the size of the circle mark is larger, it means the persuasive power is higher. The distance between the circles indicates the proximity of persuasive power. The presence of a large CR is suggested when there is a large circle mark away from the cross mark.

Further, the evaluation analysis data extraction part 330 can extract various rating data of each evaluator stored in the evaluator rating data file 346, and transmit the rating data from the transceiver 310 to the administrator terminal 13 via the computer network 14 in a displayable form. Examples of the evaluator rating data include the following.
Rating data regarding the magnitude of the persuasive power of the evaluator
Rating data regarding the magnitude of the explanatory power of the evaluator to other evaluators
Rating data regarding the magnitude of the connoisseurship of the evaluator

As the rating data regarding the magnitude of persuasive power of the evaluator, relative scores (an average value of persuasive power, a rank order of persuasive power, a weight factor, and the like) among the evaluators regarding the magnitude of persuasive power for each evaluation axis can be mentioned.

Further, the evaluation analysis data extraction part 330 can extract the rating data regarding the magnitude of the connoisseurship of the judge stored in the judge rating data file 348 for each judge, and transmit the rating data from the transceiver 310 to the administrator terminal 13 via the computer network 14 in a displayable form.

Further, the evaluation analysis data extraction part 330 can extract the evaluation data of each evaluator including the evaluation input by each evaluator in the selective evaluation input section and the descriptive comment input section stored in the evaluation data file 344, and transmit the rating data from the transceiver 310 to the administrator terminal 13 via the computer network 14 in a displayable form.

In FIG. 14, the evaluation data (“Personal evaluation”, “Comment”), the evaluation analysis data (“CI evaluation”), the rating data regarding the magnitude of the persuasive power of the evaluator (“Persuasive power score”), the rating data regarding the magnitude of explanatory power of the evaluator (“Explanatory power score”), and the rating data regarding the magnitude of the connoisseurship of the evaluator (“Connoisseurship score”) for one particular evaluator for a particular project, are displayed for each evaluation axis on the screen of the administrator terminal 13 at the same time.

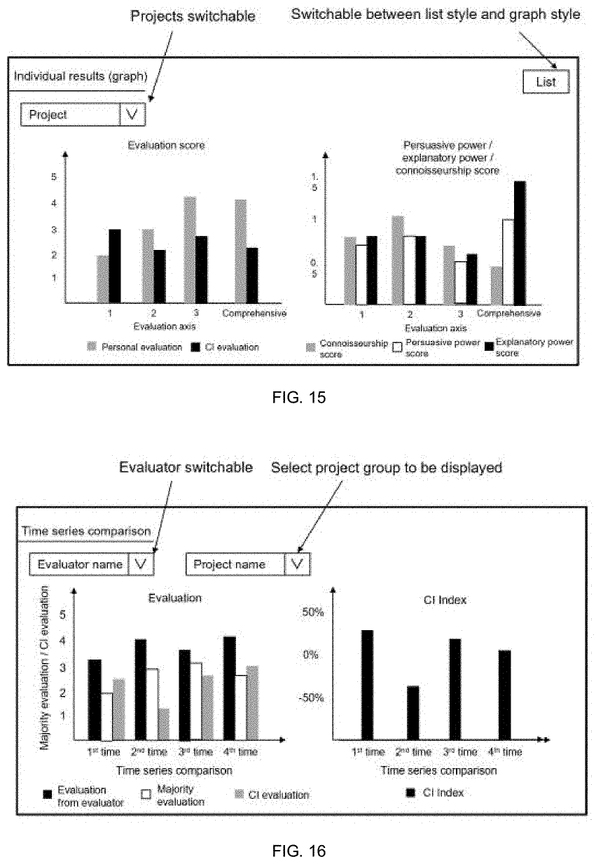

In FIG. 14, the above-mentioned various data are displayed in a list format, but the display can be switched to a graph format by clicking the “graph” on the screen. FIG. 15 shows an example of a screen when switched to the graph format. Further, as shown in FIG. 16, the result of performing the evaluation a plurality of times on the same evaluation target may be displayed in the graph at the same time. In this way, the cognitive change of the evaluator and/or the change of the evaluation due to the change of the external factor can be seen in terms of the time axis.

[Vote (evaluator, judge) terminal]

The voter terminal 12 may also contain the hardware configuration of the computer 200 described above. The storage device 202 in the voter terminal 12 may store programs such as the web browser, and additionally may permanently or temporarily store data such as browser data and data transmitted to or received from the server 11 (for example, format data, evaluation data, judgement data, evaluator rating data, judge rating data, and the like). The input device 204 of the voter terminal 12 enables inputting login information, inputting evaluations, inputting judgements, and the like. The output device 203 of the voter terminal 12 may display a login screen, a screen for evaluation input, a screen for judgement input, an evaluation analysis result, a rating result, and the like. The communicating device 205 of the voter terminal 12 enables communication with the server 11 via the computer network 14. For example, the voter terminal 12 may receive the login screen, the information on evaluation target, the format data for evaluation input, the format data for judgement input, the evaluation analysis data, and the like from the server 11, and may transmit the login information, the evaluation data, and the judgement data and the like to the server 11.

[Administrator terminal]

The administrator terminal 13 may also contain the hardware configuration of the computer 200 described above. The storage device 202 in the administrator terminal 13 may store programs such as the web browser, and additionally may permanently or temporarily store data such as browser data and data transmitted to or received from the server 11 (for example, data such as evaluator account data, evaluation progress data, judgement progress data, evaluation condition data, format data, evaluation data, judgement data, evaluator rating data, judge rating data, evaluation analysis data). The input device 204 of the administrator terminal 13 enables inputting evaluator account data, inputting login information, instruction to start the evaluation, and the like. The output device 203 of the administrator terminal 13 may display an evaluator account data, a login screen, a screen for evaluation condition input, a screen for evaluation input, a screen for judgement input, an evaluation analysis result, a rating result, and the like. The communicating device 205 of the administrator terminal 13 enables communication with the server 11 via the computer network 14. For example, the administrator terminal 13 may receive the login screen, the evaluator account data, the evaluation data, the judgement data, the evaluation analysis data, the rating data, the evaluation progress data, the judgement progress data, and the like from the server 11, and may transmit the evaluation condition data (including instruction to start evaluation), the voter account data and the login data to the server 11.

[Server Administrator Terminal]

The server administrator terminal 15 may also contain the hardware configuration of the computer 200 described above. The storage device 202 in the server administrator terminal 15 may store programs such as the web browser, and additionally may permanently or temporarily store data such as browser data and data transmitted to or received from the server 11 (for example, server administrator account data, administrator account data, voter account data, evaluation progress data, judgement progress data, evaluation data, judgement data, evaluation analysis data, rating data, and the like). The input device 204 of the server administrator terminal 15 enables inputting server administrator account data, inputting administrator account data, inputting login information, inputting evaluation conditions, and the like. The output device 203 of the server administrator terminal 15 may display a server administrator account data, an administrator account data, a login screen, a voter account data, a login screen, a screen for evaluation condition input, a screen for evaluation input, a screen for judgement input, an evaluation analysis result, a rating result, and the like. The communicating device 205 of the server administrator terminal 15 enables communication with the server 11 via the computer network 14. For example, the server administrator terminal 15 may receive the login screen, the server administrator account data, the administrator account data, the voter account data, the evaluation data, the judgement data, the evaluation analysis data, the rating data, the evaluation progress data, the judgement progress data, and the like from the server 11, and may transmit the server administrator account data, the administrator account data, the voter account data and the login information to the server 11.

<2. Flow of Online Evaluation>

Next, the procedure of the method for online evaluation by the above system will be exemplarily explained with reference to the flowchart.

(2-1 Evaluation Session)

2-1-1 from Setting Evaluation Conditions to Starting Evaluation Session

In FIG. 18 there is described a flowchart of a process flow from an administrator accessing a server to register voters and inputting evaluation conditions to displaying a screen for evaluation input on an evaluator terminal. When the administrator inputs a predetermined URL from the administrator terminal 13 to access the server 11, the server 11 transmits a login screen to the administrator terminal 13 (S101A). Next, when the administrator inputs the ID and password into the administrator terminal 13 and presses the login button (S102A), the authentication processing part 321 of the server 11 determines whether or not the entered group ID and password match the data stored in the administrator account file 349 (S103A). If they match, an administration screen for the administrator is transmitted to the administrator terminal 13 (S104A), and if they do not match, an error message is transmitted (S105A).

When the login is successful, an administration screen (example: FIGS. 6 and 7) is displayed on the administrator terminal 13. The administrator inputs the voter information and the evaluation conditions on the administration screen and transmits them to the server 11 (S106A). When the server 11 receives the data related to the voter information and the evaluation conditions, the data registration part 322 stores the data in the voter account file 341 and the evaluation condition information file 342, respectively (S107A).

Next, the server 11 transmits the administration screen for informing the registered voter information and the evaluation conditions to the administrator terminal 13 (S108A). After confirming the registered information on the administration screen, the administrator clicks the “Start evaluation session” button on the administration screen as shown in FIG. 6, so that an instruction to start the evaluation session is transmitted to the server 11. (S109A). Upon receiving the instruction to start the evaluation session transmitted from the administrator terminal 13, the evaluation input data extraction part 323a of the server 11 changes the status to a status indicating that the evaluation session has started and stores it in the voter account file 341 or the like (S110A). In addition, the start time of the evaluation session may be stored in the voter account file 341 or the like. If there is a status field in other files such as the voter account file 341 and the evaluation condition information file 342, the status is changed in the same manner.

In addition, an instruction from the administrator to start the evaluation session includes not only clicking the “start evaluation session” button but also setting a start date and time of the evaluation session in advance and registering them in the server 11. In this case, the server 11 automatically executes S110A at the set date and time.

Next, the evaluation input data extraction part 323a of the server 11 extracts evaluation conditions such as information on the evaluation target from the evaluation condition information file 342, and extracts the first format data for evaluation input from the first format data file 352, and transmits them to each evaluator terminal 12 (S111A). As a result, a screen for evaluation input such as those shown in FIG. 8-1 or FIG. 8-2 is displayed on the evaluator terminal 12 (S112A). Although the explanation in the flowchart is omitted, in order for the screen for evaluation input to be displayed on the evaluator terminal 12, the evaluator terminal 12 also needs to be logged in after being authenticated with the ID and password by the same procedure as the administrator terminal 13.

2-1-2 from the Start to the End of Evaluation Session

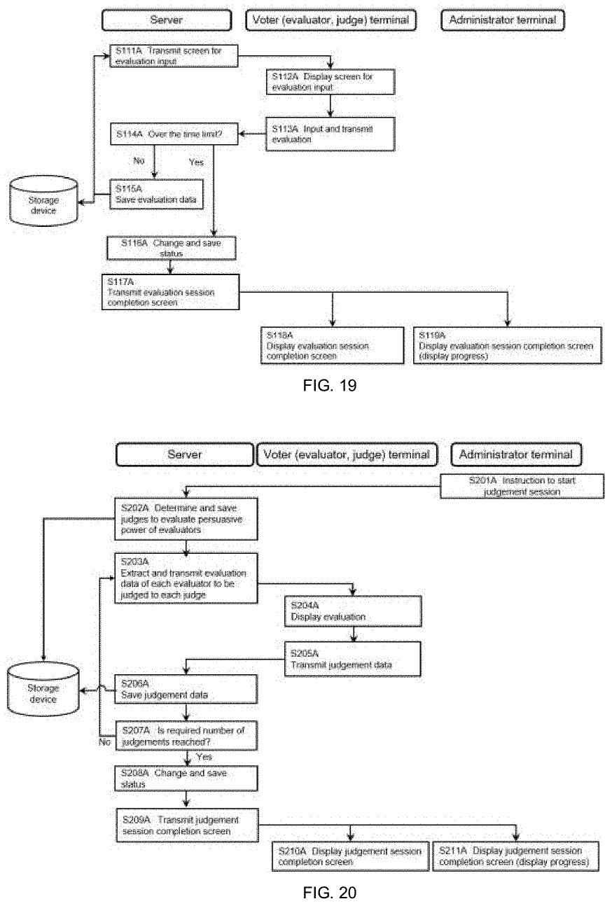

In FIG. 19, there is described a flowchart showing a process flow from the start to the end of an evaluation session. After the screen for evaluation input is displayed on the evaluator terminal 12 by the procedure described above, the evaluator inputs an evaluation according to the evaluation conditions on the screen and clicks the “Send” button. Then, the evaluation data is transmitted from the evaluator terminal 12 to the server 11 (S113A). When the server 11 receives the evaluation data, the time limit determination part 324 determines whether or not the evaluation data has been received within the time limit (S114A).

When it is determined that the evaluation data has been received within the time limit, the data registration part 322 of the server 11 assigns an evaluation ID to the evaluation data, and stores the evaluation data in the evaluation data file 344 in association with the voter ID and the like of the evaluator who has transmitted the evaluation data (S115A).

On the other hand, when the time limit determination part 324 of the server 11 receives an evaluation data over the time limit, or when it determines that the time limit has passed, regardless of whether or not an evaluation data is received from the evaluator terminal 12, it changes the status in the voter account file 341 or the like to “evaluation session ended” in order to record that the evaluation session has ended (S116A). In addition, a completion screen of evaluation session or a progress information indicating that the evaluation session has ended is transmitted to the evaluator terminal 12 and the administrator terminal 13 (S117A). In this way, the evaluator terminal 12 displays the screen indicating that the evaluation session has ended (S118A), and the administrator terminal 13 displays the progress information indicating that the evaluation session has ended, for example, as shown in FIG. 6 (S119A).

2-1-3 from the Start to the End of Judgement Session

In FIG. 20, there is described a flowchart showing a process flow from the start to the end of a judgement session. After the evaluation session is completed by the procedure described above, the administrator clicks the “Start judgement session” button on the administration screen as shown in FIG. 6, and an instruction to start a judgement session is transmitted to the server 11 (S201A). Upon receiving the instruction to start the judgement session, the judge determination part 325 of the server 11 determines judges to judge the persuasive power of the evaluator in each evaluation data stored in the evaluation data file 344 (S202A). Then, for each judge, the judge determination part 325 stores the voter ID of the judge, the evaluation ID to be judged, the required number of judgements, and the like in association with each other in the judgement progress management file 351 for managing the progress of each judgement by the judges (S202A).

In addition, the determination process by the judge determination part 325 is not limited to the instruction for starting the judgement session from the administrator terminal 13, and may be started by any instruction for starting the judge determination process. For example, the determination process may be executed by receiving an instruction only for determining the judges from the administrator terminal 13, or may be executed in accordance with other instructions, or may be executed by being triggered by a change in status to the end of the evaluation session.

Based on the evaluation ID stored in the judgement progress management file 351 and the voter ID of the judge, the judgement input data extraction part 323b of the server 11 extracts the evaluation data including the evaluation for which the persuasive power is to be judged by each judge, and extracts the second format data for inputting the judgement regarding the magnitude of the persuasive power including the selective judgement input section for each evaluation axis from the second format data file 353, and transmits them to the corresponding judge terminal 12 (S203A).

As a result, at the judge terminal 12, the evaluation for which the persuasive power is to be judged are displayed on the screen as shown in FIG. 9-1 or FIG. 9-2, in a manner in which the judge cannot identify the evaluator who has input the evaluation. The judge clicks the button for judging the persuasive power of the evaluator (for example, “Not very convinced”, “Convinced”, “Very convinced”) on the screen, and then clicks the “Send” button. Then, the judgement data is transmitted from the judge terminal 12 to the server 11 (5205A). When the server 11 receives the judgement data, the data registration part 322 assigns a judgement ID to the judgement data and stores the judgement data in the judgement data file 345 in association with the voter ID of the judge who has transmitted the judgement data and the evaluation ID, and the like (5206A).

Next, each time the judgement number determination part 334 of the server 11 receives a judgement for one evaluation from the judge terminal 12, it increases the number of completed judgements in the judgement progress management file 351 corresponding to the voter ID of the judge by one, and determines whether or not the evaluator has reached the required number of judgements according to the above determination (5207A). As a result, if it is determined that the required number of judgements has not been reached, the judgement input data extraction part 323b extracts the evaluation data including the evaluation to be judged next by the judge based on the evaluation ID and the voter ID of the judge stored in the judgement progress management file 351, and extracts the second format data for inputting the judgement regarding the magnitude of persuasive power including the selective judgement input section for each evaluation axis from the second format data file 353, and transmit them to each corresponding judge terminal 12 (S203A). In this way, the evaluation data for which the persuasive power is to be judged is repeatedly transmitted to the corresponding judge terminal 12 until the required number of judgements is reached.

Alternatively, in S203A, the server 11 may collectively transmit the evaluation data for which the persuasive power is to be judged to each determination terminal 12. Further, the judge terminal 12 may be able to collectively transmit the judgement data to the server 11 in S205A. In this case, the server 11 can receive all the judgement data from the judge at once, so it is not necessary to repeat S203A.

On the other hand, when the judgement number determination part 334 of the server 11 determines that the required number of judgements has been reached, it changes the status in the voter account file 341 or the like to “judgement session ended” in order to record that the judgement session has ended (S208A). In addition, the judgement number determination part 334 transmits a completion screen of judgement session or a progress information indicating that the judgement session has ended to the judge terminal 12 and the administrator terminal 13 (S209A). When the judge terminal 12 and the administrator terminal 13 receive such screen or progress information, the judge terminal 12 displays a screen indicating that the judgement session has ended (S210A), and the administrator terminal 13 also displays a progress information indicating that the judgement session has ended (S211A).

2-1-4 Evaluation Analysis

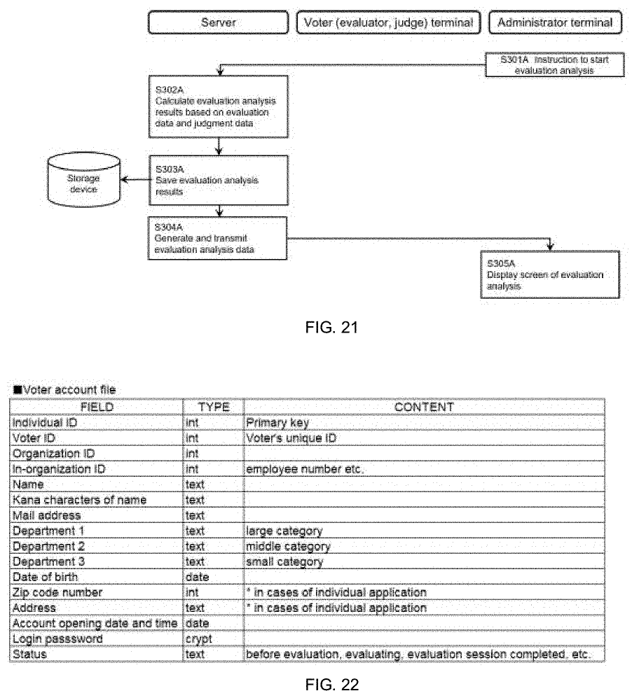

In FIG. 21, there is described a flowchart from the end of a judgement session through the evaluation analysis for the evaluation target by server 11 to the transmission of the result to the administrator terminal 13. After the judgement session is completed by the procedure described above, the administrator transmits the instruction to start the evaluation analysis from the administrator terminal 13 to the server 11 by, for example, the administrator clicking the “Start evaluation analysis” button on the administration screen as shown in FIG. 6 (S301A). In addition, the “Start evaluation analysis” button may appear on the administrator's administration screen after the judgement session ends. Next, when the server 11 receives the instruction, based on the evaluation data stored in the evaluation data file 344 and the judgement data stored in the judgement data file 345, and the like, the evaluation analysis part 328 of the server 11 generates, for example, the following evaluation analysis data (S302A).
Pre-weighted evaluation distribution and weighted evaluation distribution
First aggregated score and second aggregated score
Score fluctuation risk
Confidence score
First comprehensive evaluation score and second comprehensive evaluation score
Corrected first comprehensive evaluation score and corrected second comprehensive evaluation score
Rating data regarding the magnitude of the persuasive power of the evaluator
Rating data regarding the magnitude of the explanatory power of the evaluator to other evaluators
Rating data regarding the magnitude of the connoisseurship of the evaluator

The evaluation analysis data including the evaluation analysis result for the evaluation target is stored in the evaluation analysis data file 347, the evaluator rating data file 346, and the judge rating data file 348 according to the type of data (S303A). The evaluation analysis data extraction part 330 of the server 11 extracts the evaluation analysis data and transmits it to the administrator terminal 13 (S304A). The evaluation analysis data may also be transmitted to the voter terminal 12 in addition to the administrator terminal 13. The evaluation analysis data to be transmitted to the voter terminal 12 can be set in advance by the administrator. When the evaluation analysis data is received, the evaluation analysis data is displayed on the screen of the administrator terminal 13 (5305A).

### DESCRIPTION OF REFERENCE NUMERALS

11 Server
12 Voter (evaluator, judge) terminal
13 Administrator terminal
14 Computer network
15 Server administrator terminal
205 Communication device
200 Computer
201 Calculator
202 Storage device
203 Output device
204 Input device
205 Communication device
206 Random number generator
207 Timer
310 Transceiver
320 Control unit
321 Authentication processing part
322 Data registration department
323a Evaluation input data extraction part
323b Judgement input data extraction part
324 Time limit judgement unit
325 Judgement determination department
328 Evaluation analysis part
330 Evaluation analysis data extraction part
334 Judgement number determination unit
340 Storage unit
341 Voter account file
342 Evaluation condition information file
344 Evaluation data file
345 Judgement data file
346 Evaluator rating data file
347 Evaluation analysis data file
348 Judge rating data file
349 Administrator account file
350 Server administrator account file
351 Judgement progress management file
352 First format data file
353 Second format data file

1. A method for online evaluation, comprising:
a step in which a server receives an instruction to start an evaluation session from an administrator terminal via a network;
a step in which, in response to the instruction to start the evaluation session, the server extracts information on an evaluation target from an evaluation target information storage part, and extracts a first format data for evaluation input including a selective evaluation input section based on at least one evaluation axis and at least one descriptive comment input section from a first format data storage part, and transmits the information on the evaluation target and the first format data to each of a plurality of evaluator terminals of the evaluation session via the network;
a step in which the server receives an evaluation data including evaluation of the evaluation target input by each evaluator in the selective evaluation input section and the descriptive comment input section from each of the evaluator terminals via the network;
a step in which the server assigns an identifier to each of the received evaluation data including the evaluation of the evaluation target, and stores the evaluation data in an evaluation data storage part in association with an identifier of each evaluator who has transmitted the evaluation data;
a step in which the server determines judges from among the evaluators who should judge a persuasive power of the evaluator in each evaluation data stored in the evaluation data storage part;
a step in which, according to the result of the step of determining the judges who should judge the persuasive power of the evaluator, the server extracts the evaluation data including the evaluation to be judged by each judge from the evaluation data storage part, and extracts a second format data including a selective judgement input section for inputting judgement regarding a magnitude of the persuasive power for each evaluation axis from a second format data storage part, and transmits the evaluation data and the second format data to a corresponding judge terminal via the network in a manner in which the judge cannot identify the evaluator who has input the evaluation;
a step in which the server receives judgement data including the judgement of the persuasive power of the evaluator input by each judge in the selective judgement input section from each judgement terminal via the network;
a step in which the server assigns an identifier to each of the received judgement data and stores the judgement data in a judgement data storage part in association with the identifier of the judge who has transmitted the judgement data and with the identifier of the evaluation data which has received the judgement;
a step in which the server ranks the persuasive power of each evaluator who has received the judgement for each evaluation axis based on the judgement regarding the magnitude of the persuasive power of the evaluator input by each judge in the selective judgement input section in the judgement data stored in the judgement data storage part, and stores as rating data regarding the magnitude of the persuasive power of the evaluator in an evaluator rating data storage part in association with the identifier of each evaluator;
a step in which the server calculates a weighted evaluation distribution for the evaluation target for each evaluation axis, based on the evaluation input by each evaluator in the selective evaluation input section in the evaluation data stored in the evaluation data storage part and the rating regarding the magnitude of the persuasive power of each evaluator stored in the evaluator rating data storage part, provided that as the rating regarding the magnitude of the persuasive power of the evaluator is higher, a greater weighting is given to the evaluation by the evaluator, and the sever stores the weighted evaluation distribution in an evaluation analysis data storage part for each evaluation axis; and
a step in which the server extracts an evaluation analysis data including the weighted evaluation distribution itself and/or statistics calculated based on the evaluation distribution stored in the evaluation analysis data storage part, and transmits the evaluation analysis data to the administrator terminal via the network.

2. The method for online evaluation according to claim 1, wherein the step, in which the server ranks the persuasive power of each evaluator who has received the judgement for each evaluation axis based on the judgement regarding the magnitude of the persuasive power of the evaluator input by each judge in the selective judgement input section in the judgement data stored in the judgement data storage part, and stores as the rating data regarding the magnitude of the persuasive power of the evaluator in the evaluator rating data storage part in association with the identifier of each evaluator, comprises a step in which the server ranks a first magnitude of the persuasive power of each evaluator who has received the judgement for each evaluation axis based on the judgement regarding the magnitude of the persuasive power of the evaluator input by each judge in the selective judgement input section, and stores as a first rating data regarding the magnitude of the persuasive power of the evaluator in the evaluator rating data storage part in association with the identifier of each evaluator; followed by a step performed at least once in which the server ranks a second magnitude of the persuasive power of each evaluator who has received the judgement for each evaluation axis, based on the judgement regarding the persuasive power of the evaluator input by each judge in the selective judgement input section and the first rating data stored in the evaluator rating data storage part, provided that as the rating regarding the first magnitude of the persuasive power of the evaluator is higher, a greater weighting is given to the judgement by the evaluator, and the server stores as a second rating data regarding the magnitude of the persuasive power of the evaluator in the evaluator rating data storage part in association with the identifier of each evaluator.

3. The method for online evaluation according to claim 1, further comprising:
a step in which the server calculates a pre-weighted evaluation distribution for the evaluation target for each evaluation axis based on the evaluation input by each evaluator in the selective evaluation input section in the evaluation data stored in the evaluation data storage part, and stores the pre-weighted evaluation distribution in the evaluation analysis data storage part for each evaluation axis; and
a step in which the server extracts an evaluation analysis data including the pre-weighted evaluation distribution itself and/or statistics calculated based on the evaluation distribution stored in the evaluation analysis data storage part, and transmits the evaluation analysis data to the administrator terminal via the network.

4. The method for online evaluation according to claim 1, further comprising:
a step in which the server calculates a first aggregated score of the evaluation of the evaluation target for each evaluation axis based on the evaluation input by each evaluator in the selective evaluation input section in the evaluation data stored in the evaluation data storage part, and stores the first aggregated score in the evaluation analysis data storage part for each evaluation axis;
a step in which the server calculates a second aggregated score of the evaluation for the evaluation target for each evaluation axis based on the evaluation input by each evaluator in the selective evaluation input section in the evaluation data stored in the evaluation data storage part and the rating regarding the magnitude of the persuasive power of each evaluator stored in the evaluator rating data storage part, provided that as the rating regarding the magnitude of the persuasive power of the evaluator is higher, a greater weighting is given to the evaluation by the evaluator, and the sever stores the second aggregated score in the evaluation analysis data storage part for each evaluation axis; and
a step in which the server extracts an evaluation analysis data including the first aggregated score and the second aggregated score stored in the evaluation analysis data storage part and transmits the evaluation analysis data to the administrator terminal via the network.

5. The method for online evaluation according to claim 4, further comprising:
a step in which the server aggregates a score fluctuation risk for each evaluation axis based on a magnitude of a difference between the evaluation input by each evaluator in the selective evaluation input section in the evaluation data stored in the evaluation data storage part and the second aggregated score in the evaluation analysis data stored in the evaluation analysis data storage part, and based on the rating regarding the magnitude the persuasive power of each evaluator stored in the evaluator rating data storage part, and the server stores the score fluctuation risk in the evaluation analysis data storage part, wherein as the rating regarding the magnitude of the persuasive power of the evaluator is higher, a greater weighting is given to the evaluation by the evaluator when aggregating the score fluctuation risk; and
a step in which the server extracts an evaluation analysis data including the score fluctuation risk stored in the evaluation analysis data storage part and transmits the evaluation analysis data to the administrator terminal via the network.

6. The method for online evaluation according to claim 4, further comprising:
a step in which the server compares the evaluation input by each evaluator in the selective evaluation input section in the evaluation data stored in the evaluation data storage part and the second aggregated score in the evaluation analysis data stored in the evaluation analysis data storage part, and provided that a higher rating is given as proximity between them is higher, the server ranks a magnitude of a connoisseurship of each evaluator for each evaluation axis, and stores a rating data regarding the magnitude of the connoisseurship of the evaluator in the evaluator rating data storage part in association with the identifier of each evaluator; and
a step in which the server extracts the rating data regarding the magnitude of the connoisseurship of the evaluator stored in the evaluator rating data storage part for each evaluator and transmits the rating data to the administrator terminal via the network.

7. The method for online evaluation according to claim 4, further comprising:
a step in which the server calculates a first comprehensive evaluation score for the evaluation target based on the first aggregated score for each evaluation axis in the evaluation analysis data stored in the evaluation analysis data storage part, and stores the first comprehensive evaluation score in the evaluation analysis data storage part;
a step in which the server calculates a second comprehensive evaluation score for the evaluation target based on the second aggregated score for each evaluation axis in the evaluation analysis data stored in the evaluation analysis data storage part, and stores the second comprehensive evaluation score in the evaluation analysis data storage part; and
a step in which the server extracts an evaluation analysis data including the first comprehensive evaluation score and the second comprehensive evaluation score stored in the evaluation analysis data storage part and transmits the evaluation analysis data to the administrator terminal via the network.

8. The method for online evaluation according to claim 7, further comprising:
a step in which the server receives an instruction from the administrator terminal via the network to change a degree of influence of the aggregated score of each evaluation axis on the comprehensive evaluation score;
a step in which the server changes the degree of influence that the first aggregated score for each evaluation axis has on the first comprehensive evaluation score in response to the instruction to change the degree of influence, and calculates a corrected first comprehensive evaluation score for the evaluation target based on the first aggregated score for each evaluation axis in the evaluation analysis data stored in the evaluation analysis data storage part, and stores the corrected first comprehensive evaluation score in the evaluation analysis data storage part;
a step in which the server changes the degree of influence that the second aggregated score has on the second comprehensive evaluation score for each evaluation axis in response to the instruction to change the degree of influence, and calculates a corrected second comprehensive evaluation score for the evaluation target based on the second aggregated score of each evaluation axis in the evaluation analysis data stored in the evaluation analysis data storage part, and stores the corrected second comprehensive evaluation score in the evaluation analysis data storage part; and
a step in which the server transmits the corrected first comprehensive evaluation score and the corrected second comprehensive evaluation score stored in the evaluation analysis data storage part to the administrator terminal via the network.

9.-12. (canceled)

13. The method for online evaluation according to claim 1, further comprising:
a step in which the server ranks a magnitude of an explanatory power of each evaluator who has received the judgement for each evaluation axis, based on the judgement regarding the magnitude of the persuasive power of the evaluator input by each judge in the selective judgement input section in the judgement data stored in the judgement data storage part and based on a magnitude of a difference between the evaluation of the evaluation target input by the judge and the evaluation of the evaluation target input by the evaluator who has received the judgement from the judge in the evaluation data stored in the evaluation data storage part, provided that a higher rating is given as the magnitude of the persuasive power and the difference in the evaluation are greater, and the server stores as a rating data regarding the magnitude of the explanatory power of the evaluator in the evaluator rating data storage part in association with the identifier of each evaluator; and
a step in which the server extracts the rating data regarding the magnitude of the explanatory power of the evaluator stored in the evaluator rating data storage part for each evaluator and transmits the rating data to the administrator terminal via the network.

14. The method for online evaluation according to claim 1, further comprising a step in which the server extracts for each evaluator the evaluation data including the evaluation input by each evaluator in the selective evaluation input section and the descriptive comment input section, and transmits the evaluation data to the administrator terminal via the network.

15. The method for online evaluation according to claim 1, further comprising:
a step in which the server compares the judgement regarding the magnitude of the persuasive power of the evaluator input by each judge in the selective judgement input section in the judgement data stored in the judgement data storage part and the rating regarding the magnitude of the persuasive power of the evaluator stored in the evaluator rating data storage part, and provided that a higher rating is given as proximity between them is higher, the server ranks a magnitude of a connoisseurship of each judge for each evaluation axis, and stores as a rating data regarding the magnitude of the connoisseurship of the judge in a judge rating data storage part in association with the identifier of each judge; and
a step in which the server extracts the rating data regarding the magnitude of the connoisseurship of the judge stored in the judge rating data storage part for each judge and transmits the rating data to the administrator terminal via the network.

16. The method for online evaluation according to claim 1, wherein the second format data further includes a selective evaluation re-input section for inputting a re-evaluation of the evaluation target for each evaluation axis, and the judgement data further includes a re-evaluation data including a re-evaluation of the evaluation target input by each judge in the selective evaluation re-input section.

17. The method for online evaluation according to claim 16, wherein the rating by the server on the magnitude of the persuasive power of each evaluator who has received the judgement for each evaluation axis is performed based on the judgement regarding the magnitude of persuasive power of the evaluator input by each judge in the selective judgement input section and based on the re-evaluation of the evaluation target input by each judge in the selective evaluation re-input section, in the judgement data stored in the judgement data storage part.

18. An online server for evaluation, comprising a transceiver, a control unit, and a storage unit,
the storage unit comprising:
an evaluation target information storage part for storing information on an evaluation target;
a first format data storage part for storing a first format data for evaluation input including a selective evaluation input section based on at least one evaluation axis and at least one descriptive comment input section;
an evaluation data storage part for storing an evaluation data including an evaluation of the evaluation target input by each evaluator in the selective evaluation input section and the descriptive comment input section received by the transceiver, together with an identifier of the evaluation data in association with an identifier of each evaluator who has transmitted the evaluation data;
a second format data storage part for storing a second format data including a selective judgement input section for inputting judgement regarding a magnitude of a persuasive power for each evaluation axis;
a judgement data storage part for storing a judgement data including a judgement of a persuasive power of the evaluator input by each judge in the selective judgement input section received by the transceiver, together with an identifier of the judgement data in association with an identifier of the judge who has transmitted the judgement data and the identifier of the evaluation data which has received the judgement;
an evaluation analysis data storage part for storing a weighted evaluation distribution for the evaluation target for each evaluation axis; and
an evaluator rating data storage part for storing a rating data regarding the magnitude of the persuasive power of the evaluator in association with the identifier of each evaluator;
the control unit comprising an evaluation input data extraction part, a judgement input data extraction part, a data registration part, a judge determination part, an evaluation analysis part, and an evaluation analysis data extraction part, wherein:
the evaluation input data extraction part is configured to extract the information on the evaluation target from the evaluation target information storage part when the transceiver receives an instruction to start an evaluation session from an administrator terminal via a network, and to extract the first format data for evaluation input including the selective evaluation input section based on the at least one evaluation axis and the at least one descriptive comment input section from the first format data storage part, and to transmit the information on the evaluation target and the first format data to each of a plurality of evaluator terminals of the evaluation session from the transceiver via the network;
the data registration part is configured to assign the identifier to each of the evaluation data received by the transceiver, and store the evaluation data in the evaluation data storage part in association with the identifier of each evaluator who has transmitted the evaluation data, and is configured to assign the identifier to each of the judgement data received by the transceiver, and store the judgement data in the judgement data storage part in association with the identifier of the judge who has transmitted the judgement data and the identifier of the evaluation data which has received the judgement;
the judge determination part is configured to determine judges from among the evaluators who should judge the persuasive power of the evaluator in each evaluation data stored in the evaluation data storage part;
the judgement input data extraction part is configured to extract the evaluation data including the evaluation to be judged by each judge from the evaluation data storage part according to a determination by the judge determination part on the judges who should judge the persuasive power of the evaluator, and is configured to extract the second format data including the selective judgement input section for inputting judgement regarding the magnitude of the persuasive power for each evaluation axis from the second format data storage part, and to transmit the evaluation data and the second format data from the transceiver to a corresponding judge terminal via the network in a manner in which the judge cannot identify the evaluator who has input the evaluation;
the evaluation analysis part is configured to rank the magnitude of the persuasive power of each evaluator who has received the judgement for each evaluation axis based on the judgement regarding the magnitude of the persuasive power of the evaluator input by each judge in the selective judgement input section in the judgement data stored in the judgement data storage part, and to store as a rating data regarding the magnitude of the persuasive power of the evaluator in the evaluator rating data storage part in association with the identifier of each evaluator,
and the evaluation analysis part is configured to calculate the weighted evaluation distribution for the evaluation target for each evaluation axis based on the evaluation input by each evaluator in the selective evaluation input section in the evaluation data stored in the evaluation data storage part and the rating regarding the magnitude of the persuasive power of each evaluator stored in the evaluator rating data storage part, provided that as the rating regarding the magnitude of the persuasive power is higher, a greater weighting is given to the evaluation by the evaluator, and is configured to store the weighted evaluation distribution in the evaluation analysis data storage part for each evaluation axis; and
the evaluation analysis data extraction part is configured to extract an evaluation analysis data including the weighted evaluation distribution itself and/or statistics calculated based on the evaluation distribution stored in the evaluation analysis data storage part, and to transmit the evaluation analysis data from the transceiver to the administrator terminal via the network.

19. The online server for evaluation according to claim 18, wherein when the evaluation analysis part ranks the magnitude of the persuasive power of each evaluator who has received the judgement for each evaluation axis based on the judgement regarding the magnitude of the persuasive power of the evaluator input by each judge in the selective judgement input section in the judgement data stored in the judgement data storage part, and stores as the rating data regarding the magnitude of the persuasive power of the evaluator in the evaluator rating data storage part in association with the identifier of each evaluator, the evaluation analysis part is configured to perform a step in which the evaluation analysis part ranks a first magnitude of the persuasive power of each evaluator who has received the judgement for each evaluation axis based on the judgement regarding the magnitude of the persuasive power of the evaluator input by each judge in the selective judgement input section, and stores as a first rating data regarding the magnitude of the persuasive power of the evaluator in the evaluator rating data storage part in association with the identifier of each evaluator; followed by a step the evaluation analysis part is configured to perform at least once in which the evaluation analysis part ranks a second magnitude of the persuasive power of each evaluator who has received the judgement for each evaluation axis, based on the judgement regarding the persuasive power of the evaluator input by each judge in the selective judgement input section and the first rating data stored in the evaluator rating data storage part, provided that as the rating regarding the first magnitude of the persuasive power of the evaluator is higher, a greater weighting is given to the judgement by the evaluator, and the evaluation analysis part stores as a second rating data regarding the magnitude of the persuasive power of the evaluator in the evaluator rating data storage part in association with the identifier of each evaluator.

20. The online server for evaluation according to claim 18, wherein
the evaluation analysis data storage part is configured to store a pre-weighted evaluation distribution for the evaluation target;
the evaluation analysis part is configured to calculate the pre-weighted evaluation distribution for the evaluation target for each evaluation axis based on the evaluation input by each evaluator in the selective evaluation input section in the evaluation data stored in the evaluation data storage part, and to store the pre-weighted evaluation distribution in the evaluation analysis data storage part for each evaluation axis; and
the evaluation analysis data extraction part is configured to extract an evaluation analysis data including the pre-weighted evaluation distribution itself and/or the statistics calculated based on the evaluation distribution stored in the evaluation analysis data storage part, and to transmit the evaluation analysis data from the transceiver to the administrator terminal via the network.

21. The online server for evaluation according to claim 18, wherein
the evaluation analysis part is configured to calculate a first aggregated score of the evaluation of the evaluation target for each evaluation axis based on the evaluation input by each evaluator in the selective evaluation input section in the evaluation data stored in the evaluation data storage part, and to store the first aggregated score in the evaluation analysis data storage part for each evaluation axis,
and the evaluation analysis part is configured to calculate a second aggregated score of the evaluation of the evaluation target for each evaluation axis based on the evaluation input by each evaluator in the selective evaluation input section in the evaluation data stored in the evaluation data storage part and the rating regarding the magnitude of the persuasive power of each evaluator stored in the evaluator rating data storage part, provided that as the rating regarding the magnitude of the persuasive power of the evaluator is higher, a greater weighting is given to the evaluation by the evaluator, and to store the second aggregated score in the evaluation analysis data storage part for each evaluation axis; and
the evaluation analysis data extraction part is configured to extract an evaluation analysis data including the first aggregated score and the second aggregated score stored in the evaluation analysis data storage part and transmit the evaluation analysis data from the transceiver to the administrator terminal via the network.

22. The online server for evaluation according to claim 21, wherein
the evaluation analysis part is configured to aggregate a score fluctuation risk for each evaluation axis based on a magnitude of a difference between the evaluation input by each evaluator in the selective evaluation input section in the evaluation data stored in the evaluation data storage part and the second aggregated score in the evaluation analysis data stored in the evaluation analysis data storage part, and based on the rating regarding the magnitude the persuasive power of each evaluator stored in the evaluator rating data storage part, provided that as the rating regarding the magnitude of the persuasive power of the evaluator is higher, a greater weighting is given to the evaluation by the evaluator when aggregating the score fluctuation risk, and the evaluation analysis part is configured to store the score fluctuation risk in the evaluation analysis data storage part; and
the evaluation analysis data extraction part is configured to extract an evaluation analysis data including the score fluctuation risk stored in the evaluation analysis data storage part and to transmit the evaluation analysis data from the transceiver to the administrator terminal via the network.

23. The online server for evaluation according to claim 21, wherein
the evaluation analysis part is configured to compare the evaluation input by each evaluator in the selective evaluation input section in the evaluation data stored in the evaluation data storage part and the second aggregated score in the evaluation analysis data stored in the evaluation analysis data storage part, and provided that a higher rating is given as proximity between them is higher, the evaluation analysis part is configured to rank a magnitude of a connoisseurship of each evaluator for each evaluation axis, and to store a rating data regarding the magnitude of the connoisseurship of the evaluator in the evaluator rating data storage part in association with the identifier of each evaluator; and
the evaluation analysis data extraction part is configured to extract the rating data regarding the magnitude of the connoisseurship of the evaluator stored in the evaluator rating data storage part for each evaluator and to transmit the rating data from the transceiver to the administrator terminal via the network.

24. The online server for evaluation according to claim 21, wherein
the evaluation analysis part is configured to calculate a first comprehensive evaluation score for the evaluation target based on the first aggregated score for each evaluation axis in the evaluation analysis data stored in the evaluation analysis data storage part, and to store the first comprehensive evaluation score in the evaluation analysis data storage part,
and the evaluation analysis part is configured to calculate a second comprehensive evaluation score for the evaluation target based on the second aggregated score for each evaluation axis in the evaluation analysis data stored in the evaluation analysis data storage part, and to store the second comprehensive evaluation score in the evaluation analysis data storage part; and
the evaluation analysis data extraction part is configured to extract an evaluation analysis data including the first comprehensive evaluation score and the second comprehensive evaluation score stored in the evaluation analysis data storage part and to transmit the evaluation analysis data from the transceiver to the administrator terminal via the network.

25. The online server for evaluation according to claim 24, wherein when the transceiver receives an instruction from the administrator terminal via the network to change a degree of influence of the aggregated score for each evaluation axis on the comprehensive evaluation score,
the evaluation analysis part is configured to change the degree of influence that the first aggregated score for each evaluation axis has on the first comprehensive evaluation score in response to the instruction to change the degree of influence, and to calculate a corrected first comprehensive evaluation score for the evaluation target based on the first aggregated score for each evaluation axis in the evaluation analysis data stored in the evaluation analysis data storage part, and to store the corrected first comprehensive evaluation score in the evaluation analysis data storage part,
and the evaluation analysis part is configured to change the degree of influence that the second aggregated score for each evaluation axis has on the second comprehensive evaluation score in response to the instruction to change the degree of influence, and to calculate a corrected second comprehensive evaluation score for the evaluation target based on the second aggregated score for each evaluation axis in the evaluation analysis data stored in the evaluation analysis data storage part, and to store the corrected second comprehensive evaluation score in the evaluation analysis data storage part; and
the evaluation analysis data extraction part is configured to transmit the corrected first comprehensive evaluation score and the corrected second comprehensive evaluation score from the transceiver to the administrator terminal via the network.

26.-29. (canceled)

30. The online server for evaluation according to claim 18, wherein
the evaluation analysis part is configured to rank a magnitude of an explanatory power of each evaluator who has received the judgement for each evaluation axis, based on the judgement regarding the magnitude of the persuasive power of the evaluator input by each judge in the selective judgement input section in the judgement data stored in the judgement data storage part and based on a magnitude of a difference between the evaluation of the evaluation target input by the judge and the evaluation of the evaluation target input by the evaluator who has received the judgement from the judge in the evaluation data stored in the evaluation data storage part, provided that a higher rating is given as the magnitude of the persuasive power and the difference in the evaluation are greater, and the evaluation analysis part is configured to store as a rating data regarding the magnitude of the explanatory power of the evaluator in the evaluator rating data storage part in association with the identifier of each evaluator; and
the evaluation analysis data extraction part is configured to extract the rating data regarding the magnitude of the explanatory power of the evaluator stored in the evaluator rating data storage part for each evaluator and to transmit the rating data from the transceiver to the administrator terminal via the network.

31. The online server for evaluation according to claim 18, wherein the evaluation analysis data extraction part is configured to extract for each evaluator the evaluation data including the evaluation input by each evaluator in the selective evaluation input section and the descriptive comment input section stored in the evaluation data storage part, and to transmit the evaluation data from the transceiver to the administrator terminal via the network.

32. The online server for evaluation according to claim 18, wherein
the storage unit comprises a judge rating data storage part for storing a rating data regarding a magnitude of a connoisseurship of the judge in association with the identifier of each judge;
the evaluation analysis part is configured to compare the judgement regarding the magnitude of the persuasive power of the evaluator input by each judge in the selective judgement input section in the judgement data stored in the judgement data storage part and the rating regarding the magnitude of the persuasive power of the evaluator stored in the evaluator rating data storage part, and provided that a higher rating is given as proximity between them is higher, the evaluation analysis part is configured to rank the magnitude of the connoisseurship of each judge for each evaluation axis, and to store as a rating data regarding the magnitude of the connoisseurship of the judge in the judge rating data storage part in association with the identifier of each judge; and
the evaluation analysis data extraction part is configured to extract the rating data regarding the magnitude of the connoisseurship of the judge stored in the judge rating data storage part for each judge and to transmit the rating data from the transceiver to the administrator terminal via the network.

33. The online server for evaluation according to claim 18, wherein the second format data further includes a selective evaluation re-input section for inputting a re-evaluation of the evaluation target for each evaluation axis, and the judgement data further includes a re-evaluation data including a re-evaluation of the evaluation target input by each judge in the selective evaluation re-input section.

34. The online server for evaluation according to claim 33, wherein the rating by the evaluation analysis part on the magnitude of the persuasive power of each evaluator who has received the judgement for each evaluation axis is performed based on the judgement regarding the magnitude of persuasive power of the evaluator input by each judge in the selective judgement input section in the judgement data stored in the judgement data storage part and on the re-evaluation input by each judge in the selective evaluation re-input section.

35.-36. (canceled)
